(19) United States
(12) Patent Application Publication
(10) Pub. No.: US 2025/0243303 A1
(43) Pub. Date: Jul. 31, 2025

(54) DYNAMIC CROSSLINKER FOR CROSSLINKING VARIOUS TYPES OF POLYMERS AND APPLICATIONS THEREOF

(71) Applicant: The Regents of the University of California, Oakland, CA (US)

(72) Inventors: Zhibin Guan, Irvine, CA (US); Jordan Castro, Irvine, CA (US)

(21) Appl. No.: 19/041,989

(22) Filed: Jan. 30, 2025

Related U.S. Application Data
(60) Provisional application No. 63/627,055, filed on Jan. 30, 2024.

(51) Int. Cl. C08F 210/02

(52) U.S. Cl. CPC C08F 210/02; C08F 2500/07; C08F 2810/20

(57) ABSTRACT

Provided herein are dynamic crosslinkers comprising a siloxane group that is linked to terminal aromatic sulfonyl azides (ASA) that are capable of crosslinking a variety of polymers by insertion into the C—H bonds of the polymer. Additionally provided herein are processes using the dynamic crosslinker to crosslink polymers for applications, such as plastic recycling.

### CROSS-REFERENCE TO RELATED APPLICATIONS

This application claims priority to U.S. Provisional Application Ser. No. 63/627,055, filed Jan. 30, 2024, the disclosure of which is incorporated herein by reference in its entirety.

### FEDERALLY SPONSORED RESEARCH AND DEVELOPMENT

This invention was made with Government support under Grant No. DMR-1810217, awarded by the National Science Foundation, and Grant No. DE-FG02-04ER46162, awarded by the Department of Energy. The Government has certain rights in the invention.

### TECHNICAL FIELD

Provided herein is a dynamic crosslinker capable of crosslinking a variety of polymers by insertion into the C—H bonds of the polymer. Additionally provided herein are processes using the dynamic crosslinker to crosslink polymers for applications, such as plastic recycling.

### BACKGROUND OF THE INVENTION

The inherent incompatibility of polymers presents a fundamental challenge in creating polymer blends and recycling mixed plastic waste. Due to minimal entropic contribution in polymer mixing, the majority of plastics are immiscible unless there are favorable enthalpic interactions between them. Such general incompatibility results in phase separation and weak interfacial adhesion within polymer blends, yielding materials with inferior mechanical properties. Conventional compatibilization methods, including nonreactive and reactive approaches, require tailored designs specific to the chemical compositions of the polymers. This customized approach not only hinders the advancement of innovative polymer blends, but also becomes impractical for the compatibilization of mixed plastics waste due to its complex nature. Such waste typically comprises a mixture of polar and nonpolar polymers with ever changing compositions. Despite the emergence of various innovative recycling and upcycling methods for plastics, an effective closed-loop solution for recycling mixed plastic waste remains elusive. There is a pressing need to devise a practical method for the general compatibilization of immiscible mixed polymers to enable closed-loop plastic recycling.

### SUMMARY OF THE INVENTION

Creating a sustainable economy for plastics demands the exploration of new strategies for efficient management of mixed plastic waste. The inherent incompatibility of different plastics poses a major challenge in plastic mechanical recycling, resulting in phase-separated materials with inferior mechanical properties. Presented herein is a robust and efficient dynamic crosslinking chemistry that effectively compatibilizes mixed plastics. Composed of aromatic sulfonyl azides, the dynamic crosslinker shows high thermal stability and generates singlet nitrene species in situ during solvent-free melt extrusion, effectively promoting C—H insertion across diverse plastics. This innovative technology demonstrates successful compatibilization of binary polymer blends and model mixed plastics, enhancing mechanical performance and improving phase morphology. The dynamic crosslinking process disclosed herein several advantages compared to reported systems: the dynamic crosslinker disclosed herein is easy to synthesize; the nitrene is in situ generated at temperatures relevant to industrial polymer melt processing; and the nitrene insertion does not cause chain fragmentation, unlike radical processes. Accordingly, the dynamic crosslinking process of the disclosure holds promise as a practical and sustainable solution for mixed plastic waste, supporting a more sustainable lifecycle for plastics. Moreover, the dynamic crosslinking process disclosed herein also holds promise to repair damaged polymers during a recycling process.

In a certain embodiment, the disclosure provides for a dynamic crosslinker that inserts into C—H groups of a polymer or a mixture of polymers, comprising: a siloxane group; a plurality of terminal aromatic sulfonyl azide (ASA) groups; and a plurality of linking groups that connect the terminal ASA groups to the siloxane group, wherein the crosslinker inserts into C—H groups of a polymer or a mixture of polymers upon decomposition of the ASA groups. In another embodiment, decomposition of the ASA groups generates a nitrene intermediate. In yet another embodiment, the polymer or mixtures of polymers comprises synthetic polymer(s), semi-synthetic polymer(s) and/or organic polymer(s). In a further embodiment, the polymer or mixtures of polymers comprises polymers of cellulose, lignin, hyaluronic acid, chitosan, alginate, polyethylene (PE), polyethylene terephthalate (PET), poly carbonate (PC), high-density polyethylene (HDPE), low-density polyethylene (LDPE), polypropylene (PP), isotactic polypropylene (iPP), polystyrene (PS), polyvinyl chloride (PVC), poly(methyl methacrylate) (PMMA), polyethylene terephthalate (PET), Acrylonitrile Butadiene Styrene (ABS), polyoxymethylene (POM), polyamide (PA), thermoplastic polyurethane (TPU), thermoplastic elastomers (TPE) and/or polyethylene terephthalate glycol (PETg). In yet a further embodiment, the siloxane group has the structure of:

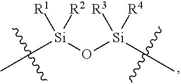

wherein, R¹-R⁴ are each individually selected from a (C₁-C₆)alkyl group and an aryl. In a particular embodiment, the siloxane group has the structure of:

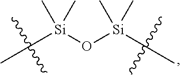 [SMILES: *[Si](C)(C)O[Si](*)(C)C]

In another embodiment, the dynamic crosslinker has 2, 3, 4, 5, 6, 7, 8, 9 or 10 terminal ASA groups. In yet another embodiment, the plurality of terminal ASA groups have the structure of:

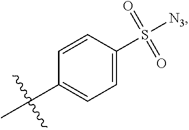 [SMILES: *c1ccc(S(=O)(=O)N=[N+]=[N-])cc1]

In a further embodiment, the plurality of linking groups have the structure of:

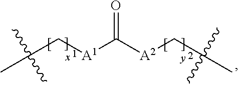

wherein, x¹ is an integer selected from 0, 1, 2, and 3; y¹ is an integer selected from 0, 1, 2, and 3; z¹ is an integer selected from 1, 2, and 3; A¹ is selected from CR⁵R⁶, NR⁷, O,

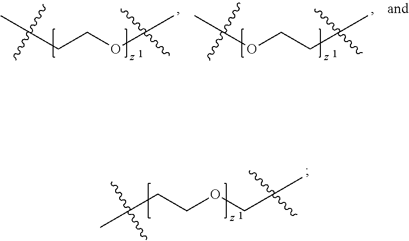

A² is selected from CR⁸R⁹, NR¹⁰, and O; and R⁵-R¹⁰ are each individually selected from H, D, optionally substituted (C₁-C₆)alkyl, optionally substituted (C₁-C₆)alkenyl, optionally substituted (C₁-C₆)alkynyl, optionally substituted aryl, optionally substituted cycloalkyl, optionally substituted heterocycle, halo, cyano, (C₁-C₅)alkoxy, thiol, sulfide, hydroxyl, aldehyde, carboxylic acid, amine, amide, (C₁-C₆)ketone, and (C₁-C₅)ester. In yet another embodiment, the plurality of linking groups have a structure selected from:

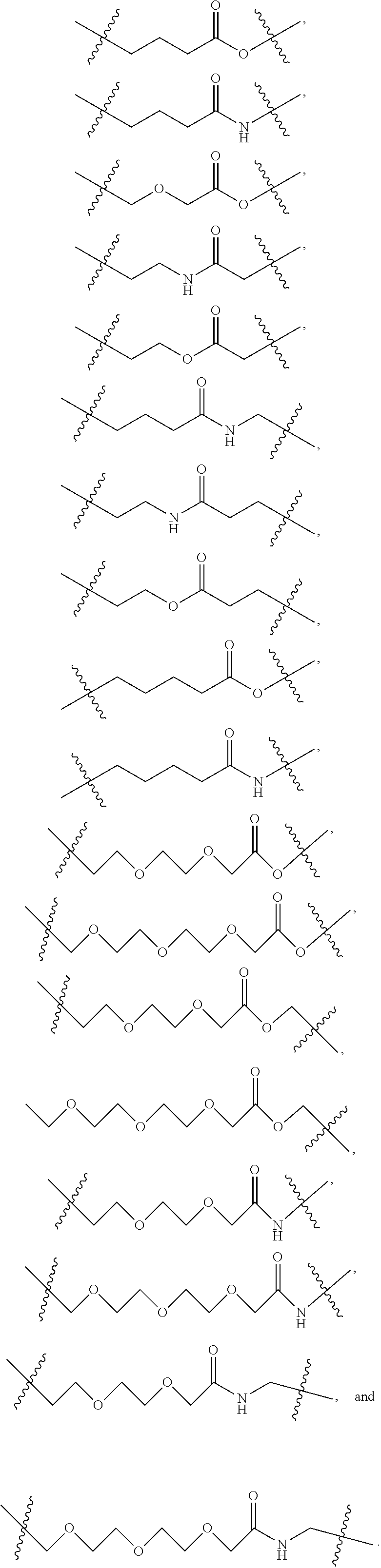

In another embodiment, the plurality of linking groups have the structure of:

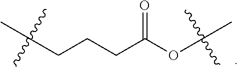 [SMILES: *CCCC(=O)O*]

In a further embodiment, the crosslinker is a bis-ASA crosslinker having the structure of:

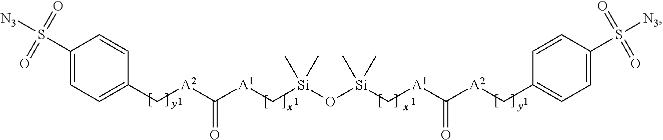

wherein, x¹ is an integer selected from 0, 1, 2, and 3; y¹ is an integer selected from 0, 1, 2, and 3; z¹ is an integer selected from 1, 2, and 3; A¹ is selected from CR⁵R⁶, NR⁷, O,

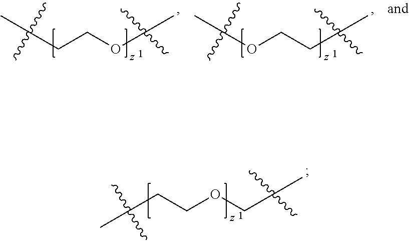

A² is selected from CR⁸R⁹, NR¹⁰, and O; R¹-R⁴ are each individually selected from a (C₁-C₆)alkyl group and an aryl; and R⁵-R¹⁰ are each individually selected from H, D, optionally substituted (C₁-C₆)alkyl, optionally substituted (C₁-C₆)alkenyl, optionally substituted (C₁-C₆)alkynyl, optionally substituted aryl, optionally substituted cycloalkyl, optionally substituted heterocycle, halo, cyano, (C₁-C₅)alkoxy, thiol, sulfide, hydroxyl, aldehyde, carboxylic acid, amine, amide, (C₁-C₆)ketone, and (C₁-C₅)ester. In a certain embodiment, the dynamic crosslinker is a bis-ASA crosslinker having the structure of:

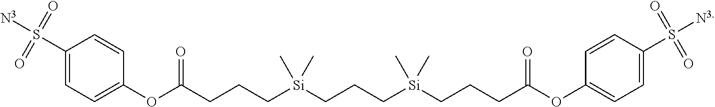 [SMILES: C[Si](C)(CCCC(=O)Oc1ccc(S(=O)(=O)N=[N+]=[N-])cc1)CCC[Si](C)(C)CCCC(=O)Oc1ccc(S(=O)(=O)N=[N+]=[N-])cc1]

In a particular embodiment, the disclosure also provides a crosslinked polymer or mixture of crosslinked polymers comprising crosslinks having the structure of:

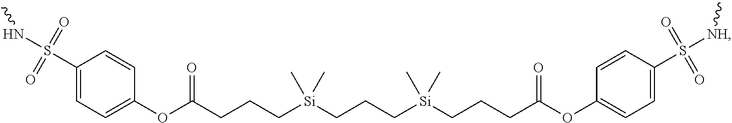

In another embodiment, the crosslinked polymer or mixture of crosslinked polymers comprise organic polymer(s), semi-synthetic polymer(s), and/or synthetic polymer(s).

In a certain embodiment, the disclosure further provides a process for introducing dynamic crosslinks into a polymer or a mixture of polymers, comprising: introducing dynamic crosslinks into a polymer or mixture of polymers by reacting one or more polymers with the dynamic crosslinker of claim 1 at an elevated temperature or under light irradiation to decompose the ASA groups of the dynamic crosslinker. In another embodiment, the reaction is carried out using an extruder in a solvent-free melt extrusion process at a temperature of 140° C., 150° C., 160° C., 170° C., 180° C., 190° C., 200° C., 210° C., 220° C., 230° C., 240° C., 250° C., 260° C., or a range that includes or is between any two of the foregoing temperatures (e.g., 140° C. to 260° C., 180° C. to 200° C., etc.). In yet another embodiment, the polymer or mixtures of polymers comprises synthetic polymer(s), semi-synthetic polymer(s) and/or organic polymer(s). In a further embodiment, dynamic crosslinking of the polymer or mixtures of polymers using the dynamic crosslinker provides for crosslinked polymers with thermoset performance and recyclability. In yet a further embodiment, the polymer or mixtures of polymers comprises polymers of mixed plastic waste, and the crosslinked plastic waste polymers are recyclable.

In a certain embodiment, the disclosure provides for a process or composition as substantially described and/or depicted herein.

The details of one or more embodiments of the disclosure are set forth in the accompanying drawings and the description below. Other features, objects, and advantages will be apparent from the description and drawings, and from the claims.

### BRIEF DESCRIPTION OF DRAWINGS

The accompanying drawings, which are incorporated into and constitute a part of this specification, illustrate one or more embodiments of the disclosure and, together with the detailed description, serve to explain the principles and implementations of the invention.

FIG. 1A-E shows the design of a bis-ASA dynamic crosslinker of the disclosure and model studies. (A) Design of bis-ASA dynamic crosslinker, and (B) C—H insertion of the singlet nitrene intermediate upon thermal decomposition of the azide. (C) DSC thermogram of bis-ASA crosslinker. (D) Stacked ¹H spectra of the bis-ASA crosslinker in cyclohexane before (black) and after (gray) heating at 180° C. for 3 h. Only key diagnostic peaks are shown in the spectra. (E) ¹H spectrum of tosyl azide in 2,4-dimethylpentane after heating at 180° C. for 1 h. Only key peaks used for calculating the reactivity ratio are shown. The reactivity ratio for the nitrene insertion to 1°:2°:3° C—H bonds was calculated to be 1.0:3.4:8.0.

FIG. 2 presents a ¹H NMR (500 MHz, CDCl₃, 298 K) spectrum for the bis-ASA crosslinker.

FIG. 3 provides a ¹³C NMR (125 MHz, CDCl₃, 298 K) spectrum for the bis-ASA crosslinker.

FIG. 4 presents a ¹H NMR (500 MHz, CDCl₃, 298 K) spectrum for the regioisomeric products of tosyl nitrene insertion to the various C—H bonds on 2,4-dimethylpentane.

FIG. 5 provides ¹³C NMR (125 MHz, CDCl₃, 298 K) spectrum for the regioisomeric products of tosyl nitrene insertion to the various C—H bonds on 2,4-dimethylpentane.

FIG. 6 presents a COSY (600 MHz, CDCl₃, 298 K) spectrum for the regioisomeric products of tosyl nitrene insertion to the various C—H bonds on 2,4-dimethylpentane.

FIG. 7 provides a ¹H NMR (500 MHz, CDCl₃, 298 K) spectrum highlighting key peak assignments for the primary insertion product of tosyl nitrene into methyl C—H bonds of 2,4-dimethylpentane.

FIG. 8 presents an expanded COSY (600 MHz, CDCl₃T, 298 K) spectrum highlighting key cross peaks for the primary insertion product of tosyl nitrene into methyl C—H bonds of 2,4-dimethylpentane.

FIG. 9 provides a ¹H NMR (500 MHz, CDCl₃, 298 K) spectrum highlighting key peak assignments for the secondary insertion product of tosyl nitrene into methylene C—H bonds of 2,4-dimethylpentane.

FIG. 10 presents an expanded COSY (600 MHz, CDCl₃T, 298 K) spectrum highlighting key cross peaks for the secondary insertion product of tosyl nitrene into methylene C—H bonds of 2,4-dimethylpentane.

FIG. 11 provides a ¹H NMR (500 MHz, CDCl₃, 298 K) spectrum highlighting key peak assignments for the tertiary insertion product of tosyl nitrene into methine C—H bonds of 2,4-dimethylpentane.

FIG. 12 presents an expanded COSY (600 MHz, CDCl₃T, 298 K) spectrum highlighting key cross peaks for the tertiary insertion product of tosyl nitrene into methine C—H bonds of 2,4-dimethylpentane.

FIG. 13 provides a ¹H NMR (500 MHz, CDCl₃, 298 K) spectrum for the bis-ASA(Cy)₂ adduct.

FIG. 14 presents a ¹³C NMR (125 MHz, CDCl₃, 298 K) spectrum for the bis-ASA(Cy)₂ adduct.

FIG. 15A-F demonstrates the dynamic crosslinking of pure plastics. (A) Pressure evolution during extrusion of iPP-x with varying bis-ASA concentrations. (B) Rheology data for iPP and iPP-x at 200° C. under different shear frequency. (C) Creep recovery test of PS and PS-x at 190° C. for 180 s under a stress of 500 Pa, followed by recovery for 180 s. (D) Stress relaxation of PETg-x at various temperatures with data fitted by the stretched exponential model. (E) TGA thermograms of HDPE and HDPE-x under atmospheres of nitrogen and air. (F) Uniaxial tensile testing of LDPE-x over five reprocessing cycles.

FIG. 16 provides photographs of swollen HDPE-x (xylenes, 120° C.) before and after the addition of excess TBAF and heating for 3.5 h.

FIG. 17 presents a DSC thermogram of HDPE and HDPE-x.

FIG. 18 provides a DSC thermogram of HDPE and HDPE-x after annealing at 100° C. for 16 h.

FIG. 19 presents a DSC thermogram of LDPE and LDPE-x.

FIG. 20 provides a DSC thermogram of iPP and iPP-x.

FIG. 21 presents a frequency sweep of HDPE and HDPE-x at 190° C.

FIG. 22 provides a frequency sweep of LDPE and LDPE-x at 190° C.

FIG. 23 presents a frequency sweep of PS and PS-x at 190° C.

FIG. 24 provides a frequency sweep of PETg and PETg-x at 190° C.

FIG. 25 presents creep of HDPE and HDPE-x at 190° C. for 180 s under a stress of 500 Pa, followed by recovery for 180 s.

FIG. 26 presents creep of LDPE and LDPE-x at 190° C. for 180 s under a stress of 500 Pa, followed by recovery for 180 s.

FIG. 27 presents creep of iPP and iPP-x at 200° C. for 180 s under a stress of 500 Pa, followed by recovery for 180 s.

FIG. 28 presents creep of PETg and PETg-x at 190° C. for 180 s under a stress of 500 Pa, followed by recovery for 180 s.

FIG. 29A-B presents (A) Full stress relaxation of PETg-x at various temperatures with (B) Arrhenius treatment of PETg-x at various temperatures with an activation energy (Ea=101 kJ/mol).

FIG. 30 provides stress relaxation of HDPE-x at 190° C.

FIG. 31 presents stress relaxation of LDPE-x at 190° C.

FIG. 32 provides stress relaxation of iPP-x at 200° C.

FIG. 33 presents stress relaxation of PS-x at 190° C.

FIG. 34 provides a TGA thermogram of HDPE and HDPE-x under an inert atmosphere of N₂.

FIG. 35 presents a TGA thermogram of HDPE and HDPE-x under an atmosphere of air.

FIG. 36 provides a TGA thermogram of LDPE and LDPE-x under an inert atmosphere of N₂.

FIG. 37 presents a TGA thermogram of iPP and iPP-x under an inert atmosphere of N₂.

FIG. 38 provides a TGA thermogram of PS and PS-x under an inert atmosphere of N₂.

FIG. 39 presents a TGA thermogram of PETg and PETg-x under an inert atmosphere of N₂.

FIG. 40 provides stress-strain curves of HDPE and HDPE-x.

FIG. 41 presents stress-strain curves of LDPE and LDPE-x.

FIG. 42 provides stress-strain curves of iPP and iPP-x.

FIG. 43 presents stress-strain curves of LDPE:PETg (60:40) and a sample modified with 3.5 wt % bis-ASA crosslinker.

FIG. 44 provides stress-strain curves of HDPE:iPP (70:30) and a sample modified with 2 wt % bis-ASA crosslinker.

FIG. 45A-G demonstrates compatibilization of binary polymer blends through dynamic crosslinking. (A) Schematic illustration for compatibilizing two immiscible polymers through dynamic crosslinking via reactive extrusion. (B) Pressure evolution during extrusion of LDPE:PETg (60:40) with and without 3.5 wt % bis-ASA. (C) Stress-strain curves for binary blends of LDPE:PETg (60:40) made with and without 3.5 wt % bis-ASA. (D) DMTA temperature sweeps of a binary blend of LDPE and PETg (60:40) and a sample modified with 3.5 wt % bis-ASA. (E) Stress-strain curves for binary blends of HDPE:iPP (70:30) made with or without 2 wt % bis-ASA. (F) SEM image of the LDPE:PETg (60:40) control blend and (G) its blend made with 3.5 wt % bis-ASA. The scale bar=10 μm.

FIG. 46 provides a ¹H NMR (500 MHz, d2-tetrachloroethane, 373 K) spectrum for the soluble fraction of HDPE:iPP-x after heating in mesitylene at 150° C. for 16 h.

FIG. 47A-F demonstrates compatibilization of a simulated mixed plastic waste. (A) Commodity plastic products used to create a simulated mixed plastic waste. The commodity plastic products were used as they are without any purification. (B) The composition of the mixed plastic blends, which is aligned with the relative volume of consumption of these plastic products. (C) DMTA temperature sweeps of a mixed plastic waste blend and a sample modified with 1 wt % bis-ASA. The unmodified sample is labeled at the point at which the sample yielded. (D) Stress-strain curves for a blend of mixed plastic waste with and without 1 wt % bis-ASA. (E) SEM image of the mixed plastic control blend, and (F) a compatibilized blend made with 1 wt % bis-ASA. The scale bar=10 μm.

FIG. 48 provides stress-strain curves for a blend of the model mixed plastics with and without 1 wt % bis-ASA over multiple reprocessing cycles.

FIG. 49 presents a photo of the model mixed plastics before reactive blending (left photo). A photo of a tensile specimen for the blend of the model mixed plastics after reactive extrusion with 1 wt % bis-ASA crosslinker followed by compression folding (right photo).

### DETAILED DESCRIPTION OF THE INVENTION

As used herein and in the appended claims, the singular forms “a,” “an,” and “the” include plural referents unless the context clearly dictates otherwise. Thus, for example, reference to “a polymer” includes a plurality of such polymers and reference to “the crosslink” includes reference to one or more crosslinks, and so forth.

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

All publications mentioned herein are incorporated by reference in full for the purpose of describing and disclosing methodologies that might be used in connection with the description herein. Moreover, with respect to any term that is presented in one or more publications that is similar to, or identical with, a term that has been expressly defined in this disclosure, the definition of the term as expressly provided in this disclosure will control in all respects.

The term “alkyl” refers to an organic group that is comprised of carbon and hydrogen atoms that contain single covalent bonds between carbons. Typically, an “alkyl” as used in this disclosure, refers to an organic group that contains 1 to 30 carbon atoms, unless stated otherwise. Where if there is more than 1 carbon, the carbons may be connected in a linear manner, or alternatively if there are more than 2 carbons then the carbons may also be linked in a branched fashion so that the parent chain contains one or more secondary, tertiary, or quaternary carbons. An alkyl may be substituted or unsubstituted (i.e., optionally substituted), unless stated otherwise. Examples of substitutions for alkyls include, but are not limited, to halos, hydroxyls, anhydrides, carbonyls, carboxyls, carbonates, carboxylates, aldehydes, haloformyls, esters, hydroperoxy, peroxy, ethers, orthoesters, carboxamides, amines, imines, imides, azides, azos, cyanates, isocyanates, nitrates, nitriles, isonitriles, nitrosos, nitros, nitrosooxy, pyridyls, sulfhydryls, sulfides, disulfides, sulfinyls, sulfos, thiocyanates, isothiocyanates, carbonothioyls, phosphinos, phosphonos, phosphates, and silyl ethers.

The term “alkenyl” refers to an organic group that is comprised of carbon and hydrogen atoms that contains at least one double covalent bond between two carbons. Typically, an “alkenyl” as used in this disclosure, refers to organic group that contains 2 to 30 carbon atoms, unless stated otherwise. While a C₂-alkenyl can form a double bond, an alkenyl group of three or more carbons can contain more than one double bond. It certain instances the alkenyl group will be conjugated, in other cases an alkenyl group will not be conjugated, and yet other cases the alkenyl group may have stretches of conjugation and stretches of nonconjugation. Additionally, if there are more than 2 carbons, the carbon atoms may be connected in a linear manner, or alternatively if there are more than 3 carbon atoms then the carbons may also be linked in a branched fashion so that the parent chain contains one or more secondary, tertiary, or quaternary carbons. An alkenyl may be substituted or unsubstituted (i.e., optionally substituted), unless stated otherwise. Examples of substitutions for alkenyls include, but are not limited, to halos, hydroxyls, anhydrides, carbonyls, carboxyls, carbonates, carboxylates, aldehydes, haloformyls, esters, hydroperoxy, peroxy, ethers, orthoesters, carboxamides, amines, imines, imides, azides, azos, cyanates, isocyanates, nitrates, nitriles, isonitriles, nitrosos, nitros, nitrosooxy, pyridyls, sulfhydryls, sulfides, disulfides, sulfinyls, sulfos, thiocyanates, isothiocyanates, carbonothioyls, phosphinos, phosphonos, phosphates, and silyl ethers.

The term “alkynyl”, refers to an organic group that is comprised of carbon and hydrogen atoms that contains a triple covalent bond between two carbons. Typically, an “alkynyl” as used in this disclosure, refers to organic group that contains 2 to 30 carbon atoms, unless stated otherwise. While a C₂-alkynyl can form a triple bond, an alkynyl group of three or more carbons can contain more than one triple bond. Where if there are more than 2 carbon atoms, the carbons may be connected in a linear manner, or alternatively if there are more than 4 carbon atoms then the carbon atoms may also be linked in a branched fashion so that the parent chain contains one or more secondary, tertiary, or quaternary carbons. An alkynyl may be substituted or unsubstituted (i.e., optionally substituted), unless stated otherwise. Examples of substitutions for alkynyls include, but are not limited, to halos, hydroxyls, anhydrides, carbonyls, carboxyls, carbonates, carboxylates, aldehydes, haloformyls, esters, hydroperoxy, peroxy, ethers, orthoesters, carboxamides, amines, imines, imides, azides, azos, cyanates, isocyanates, nitrates, nitriles, isonitriles, nitrosos, nitros, nitrosooxy, pyridyls, sulfhydryls, sulfides, disulfides, sulfinyls, sulfos, thiocyanates, isothiocyanates, carbonothioyls, phosphinos, phosphonos, phosphates, and silyl ethers.

The term “aryl”, as used in this disclosure, refers to a conjugated planar ring system with delocalized pi electron clouds that contain only carbon as ring atoms. An “aryl” for the purposes of this disclosure encompasses from 1 to 12 aryl rings wherein when the aryl is greater than 1 ring the aryl rings are joined so that they are linked, fused, or a combination thereof. An aryl may be substituted or unsubstituted (i.e., optionally substituted), or in the case of more than one aryl ring, one or more rings may be unsubstituted, one or more rings may be substituted, or a combination thereof. Examples of substitutions for aryls include, but are not limited, to halos, hydroxyls, anhydrides, carbonyls, carboxyls, carbonates, carboxylates, aldehydes, haloformyls, esters, hydroperoxy, peroxy, ethers, orthoesters, carboxamides, amines, imines, imides, azides, azos, cyanates, isocyanates, nitrates, nitriles, isonitriles, nitrosos, nitros, nitrosooxy, pyridyls, sulfhydryls, sulfides, disulfides, sulfinyls, sulfos, thiocyanates, isothiocyanates, carbonothioyls, phosphinos, phosphonos, phosphates, and silyl ethers.

The term “heterocycle”, as used in this disclosure, refers to ring structures that contain at least 1 non-carbon ring atom, and typically comprise from 3 to 12 ring atoms. A “heterocycle” for the purposes of this disclosure encompasses from 1 to 12 heterocycle rings wherein when the heterocycle is greater than 1 ring the heterocycle rings are joined so that they are linked, fused, or a combination thereof. A heterocycle may be a hetero-aryl or nonaromatic, or in the case of more than one heterocycle ring, one or more rings may be nonaromatic, one or more rings may be hetero-aryls, or a combination thereof. A heterocycle may be substituted or unsubstituted (i.e., optionally substituted), or in the case of more than one heterocycle ring one or more rings may be unsubstituted, one or more rings may be substituted, or a combination thereof. Examples of substitutions for heterocycles include, but are not limited, to halos, hydroxyls, anhydrides, carbonyls, carboxyls, carbonates, carboxylates, aldehydes, haloformyls, esters, hydroperoxy, peroxy, ethers, orthoesters, carboxamides, amines, imines, imides, azides, azos, cyanates, isocyanates, nitrates, nitriles, isonitriles, nitrosos, nitros, nitrosooxy, pyridyls, sulfhydryls, sulfides, disulfides, sulfinyls, sulfos, thiocyanates, isothiocyanates, carbonothioyls, phosphinos, phosphonos, phosphates, and silyl ethers. Typically, the non-carbon ring atom is N, O, S, Si, Al, B, or P. In case where there is more than one non-carbon ring atom, these non-carbon ring atoms can either be the same element, or combination of different elements, such as N and O. Examples of heterocycles include, but are not limited to: a monocyclic heterocycle such as, aziridine, oxirane, thiirane, azetidine, oxetane, thietane, pyrrolidine, pyrroline, imidazolidine, pyrazolidine, pyrazoline, dioxolane, sulfolane 2,3-dihydrofuran, 2,5-dihydrofuran tetrahydrofuran, thiophane, piperidine, 1,2,3,6-tetrahydro-pyridine, piperazine, morpholine, thiomorpholine, pyran, thiopyran, 2,3-dihydropyran, tetrahydropyran, 1,4-dihydropyridine, 1,4-dioxane, 1,3-dioxane, dioxane, homopiperidine, 2,3,4,7-tetrahydro-1H-azepine homopiperazine, 1,3-dioxepane, 4,7-dihydro-1,3-dioxepin, and hexamethylene oxide; and polycyclic heterocycles such as, indole, indoline, isoindoline, quinoline, tetrahydroquinoline, isoquinoline, tetrahydroisoquinoline, 1,4-benzodioxan, coumarin, dihydrocoumarin, benzofuran, 2,3-dihydrobenzofuran, isobenzofuran, chromene, chroman, isochroman, xanthene, phenoxathiin, thianthrene, indolizine, isoindole, indazole, purine, phthalazine, naphthyridine, quinoxaline, quinazoline, cinnoline, pteridine, phenanthridine, perimidine, phenanthroline, phenazine, phenothiazine, phenoxazine, 1,2-benzisoxazole, benzothiophene, benzoxazole, benzthiazole, benzimidazole, benztriazole, thioxanthine, carbazole, carboline, acridine, pyrolizidine, and quinolizidine. In addition to the polycyclic heterocycles described above, heterocycle includes polycyclic heterocycles wherein the ring fusion between two or more rings includes more than one bond common to both rings and more than two atoms common to both rings. Examples of such bridged heterocycles include quinuclidine, diazabicyclo[2.2.1]heptane and 7-oxabicyclo[2.2.1]heptane.

The term “optionally substituted” with respect to hydrocarbons, heterocycles, and the like, refers to structures that may be substituted, or alternatively be unsubstituted. Examples of optional substitutions include, but are not limited, to halos, hydroxyls, anhydrides, carbonyls, carboxyls, carbonates, carboxylates, aldehydes, haloformyls, esters, hydroperoxy, peroxy, ethers, orthoesters, carboxamides, amines, imines, imides, azides, azos, cyanates, isocyanates, nitrates, nitriles, isonitriles, nitrosos, nitros, nitrosooxy, pyridyls, sulfhydryls, sulfides, disulfides, sulfinyls, sulfos, thiocyanates, isothiocyanates, carbonothioyls, phosphinos, phosphonos, phosphates, and silyl ethers.

For purpose of this disclosure a “siloxane group” refers to an organic compound containing a functional group of two silicon atoms bound to an oxygen atom. In a particular embodiment, a “siloxane group” refers to a group having the general formula of [—R₂Si—O—SiR₂—] where the R groups can be alkyls.

The term “substituted” with respect to hydrocarbons, heterocycles, and the like, refers to structures wherein hydrogen atoms have been replaced by a substituent.

The term “substituent” refers to an atom or group of atoms substituted in place of a hydrogen atom. For purposes of this disclosure, a substituent would include deuterium atoms.

The term “unsubstituted” with respect to hydrocarbons, heterocycles, and the like, refers to structures wherein the parent chain comprises no substituents.

As used herein, a wavy line intersecting another line that is connected to an atom indicates that this atom is covalently bonded to another entity that is present but not being depicted in the structure. A wavy line that does not intersect a line but is connected to an atom indicates that this atom is interacting with another atom by a bond or some other type of identifiable association.

Despite the emergence of various innovative recycling and upcycling methods for plastics, an effective closed-loop solution for recycling mixed plastic waste remains elusive. There is a pressing need to devise a practical method for the general compatibilization of immiscible mixed polymers to enable closed-loop plastic recycling. Toward this direction, a strategy using dynamic covalent crosslinking for the compatibilization of mixed polymers has been developed. The creation of dynamic covalent bridges between different polymers enhances their compatibility, and the reversible nature of dynamic covalent crosslinks allows for thermal reprocessability, drawing inspiration from the principles pioneered in covalent adaptable networks and vitrimers. Indeed, recent efforts to exploit dynamic covalent chemistry in phase-separated vitrimers has given rise to tunable mechanical properties based on morphology, as well as high-throughput reprocessing. Dynamic crosslinking can be achieved through interchain double C—H insertion of carbene intermediates formed from bis(diazirine)-based dynamic crosslinkers. Additionally, dynamic crosslinking can be introduced through in situ radical grafting by reactive extrusion. While these innovations mark major strides toward recycling mixed plastic waste, both systems have practical limitations. The radical grafting method suffers from low efficiency and can cause polymer degradation through β-scission. While the carbene insertion mechanism addresses issues associated with radical processes, the laborious and costly multistep synthesis of bis(diazirine)-based crosslinkers, combined with processes involving solvent-coating and oven baking, presents practical challenges. Furthermore, their relatively low temperature for generating reactive carbene species (≈138° C.) limits practical application for many plastics, as most undergo melt processing at or above 180° C. A robust, scalable, and temperature-matched dynamic crosslinking chemistry is critically needed for practical applications in compatibilization of immiscible mixed plastics.

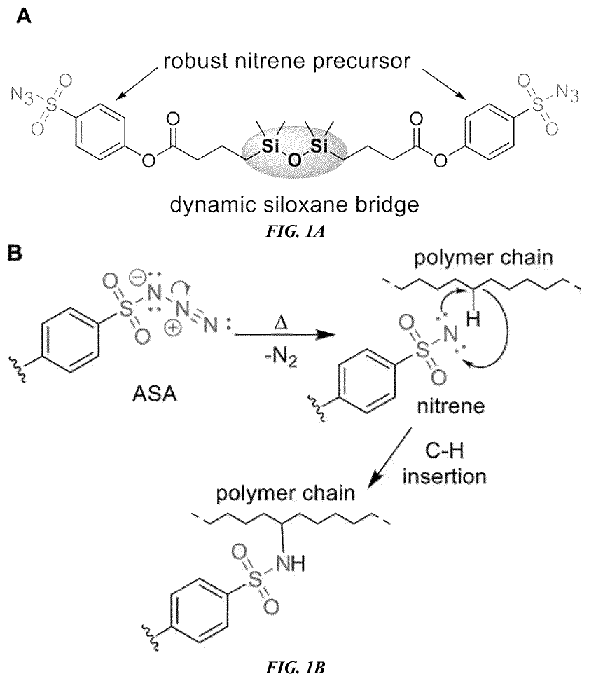

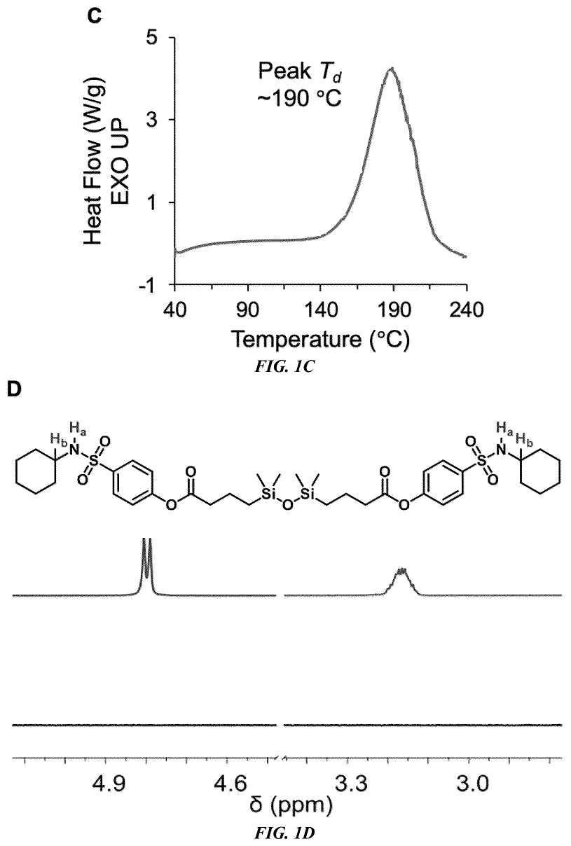

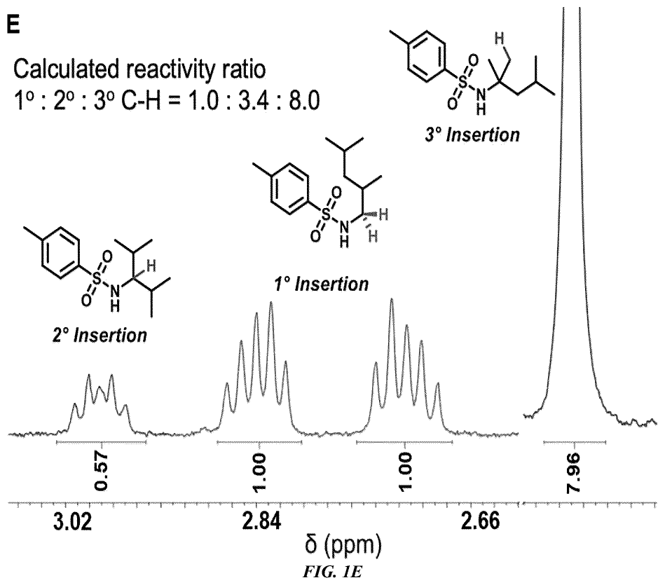

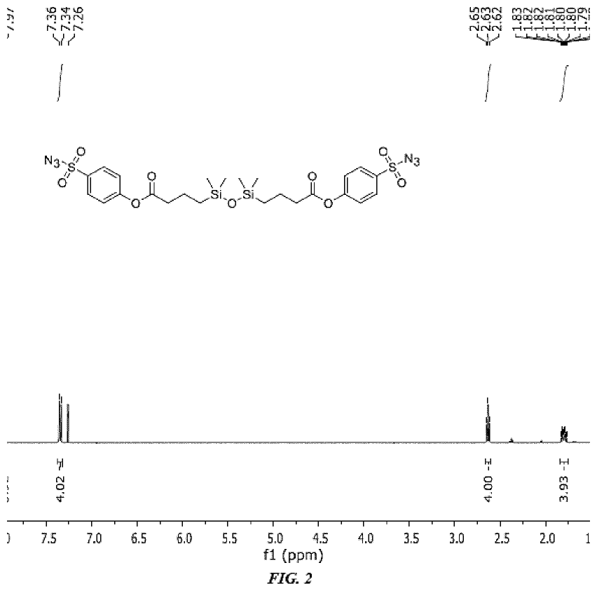

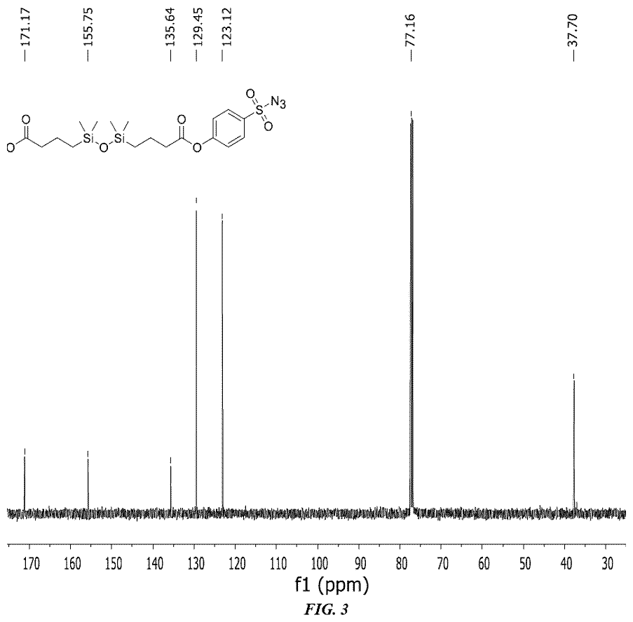

Reported herein is a new dynamic crosslinking chemistry that offers a practical solution for improving compatibility in immiscible mixed polymers. The new dynamic crosslinker disclosed herein features a siloxane group flanked by two aromatic sulfonyl azides (ASA) on both ends (see FIG. 1A). The thermal decomposition of aromatic sulfonyl azides generates highly reactive singlet nitrene species capable of inserting almost any C—H bonds in diverse polymers to induce dynamic crosslinking. Notably, the nitrene system exhibits a distinct advantage over the carbene analog as ASA decomposes at a significantly higher temperature in creating nitrene species (peak decomposition at ˜190° C. for ASA, FIG. 1C, compared to ˜138° C. for diazirine), rendering it suitable for the typical melt processing of numerous commodity plastics. Additionally, the dynamic crosslinker of the disclosure is easily accessible through a two-step synthesis from readily available commercial starting materials. The selection of the siloxane bridge as the dynamic covalent motif is informed by its demonstrated reversible exchange chemistry at elevated temperatures in the presence of a mild fluoride catalyst, along with its high stability against hydrolysis, oxidation, and thermal conditions. By integrating the robust ASA motif with the stable siloxane dynamic covalent bond (see FIG. 1A), the disclosure provides a robust and temperature-matched dynamic crosslinker for compatibilization of immiscible mixed plastics.

In a particular embodiment, the disclosure provides a dynamic crosslinker that inserts into C—H groups of a polymer or a mixture of polymers, comprising: a siloxane group; a plurality of terminal aromatic sulfonyl azide (ASA) groups; and a plurality of linking groups that connect the terminal ASA groups to the siloxane group, wherein the crosslinker inserts into C—H groups of a polymer upon thermal decomposition of the ASA groups. The siloxane group of a dynamic crosslinker disclosed herein is dynamic in that the siloxane group can undergo reversible exchange chemistry at elevated temperatures in the presence of a mild fluoride catalyst. Further, the siloxane group of the crosslinker has high stability against hydrolysis, oxidation, and thermal conditions. In another embodiment, the siloxane group of the dynamic crosslinker has the structure of:

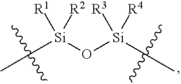

where R¹-R⁴ are each individually selected from methyl, ethyl, or propyl. In yet another embodiment, the siloxane group has the structure of:

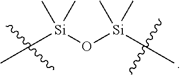 [SMILES: *[Si](C)(C)O[Si](*)(C)C]

The terminal ends of the crosslinker comprise ASA groups. The terminal ASA groups can have identical structures or can have different structures. For example, one ASA group can have additional or different aryl substitutions than the other ASA group. In a particular embodiment, a dynamic crosslinker disclosed herein has terminal ASA groups with identical structures. In a further embodiment, the ASA groups of the dynamic crosslinker of the disclosure have the structure of:

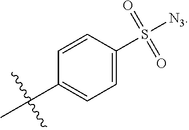 [SMILES: *c1ccc(S(=O)(=O)N=[N+]=[N-])cc1]

The plurality of linking groups can have identical structures or can have different structures. In a particular embodiment, a dynamic crosslinker disclosed herein comprises a plurality of linking groups that have the structure of:

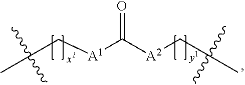

wherein, x¹ is an integer selected from 0, 1, 2, and 3; y¹ is an integer selected from 0, 1, 2, and 3; z¹ is an integer selected from 1, 2, and 3; A¹ is selected from CR⁵R⁶, NR⁷, O,

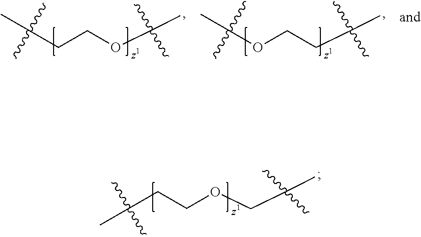

A² is selected from CR⁸R⁹, NR¹⁰, and O; and R⁵-R¹⁰ are each individually selected from H, D, optionally substituted (C₁-C₆)alkyl, optionally substituted (C₁-C₆)alkenyl, optionally substituted (C₁-C₆)alkynyl, optionally substituted aryl, optionally substituted cycloalkyl, optionally substituted heterocycle, halo, cyano, (C₁-C₅)alkoxy, thiol, sulfide, hydroxyl, aldehyde, carboxylic acid, amine, amide, (C₁-C₆)ketone, and (C₁-C₅)ester. In a further embodiment, a dynamic crosslinker disclosed herein comprises a plurality of linking groups that have a structure selected from:

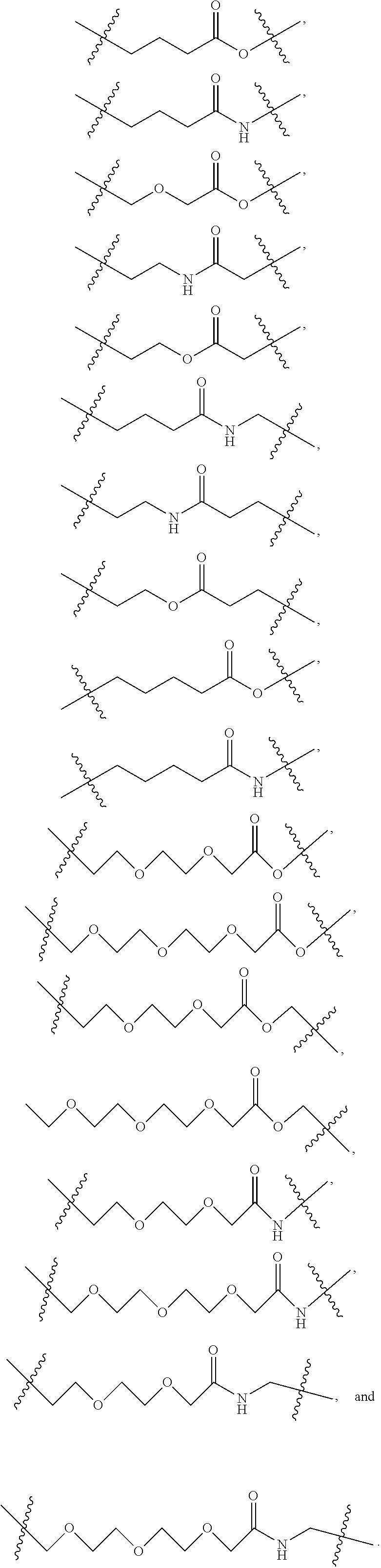

In yet a further embodiment, a dynamic crosslinker disclosed herein comprises a plurality of linking groups that have the structure selected of:

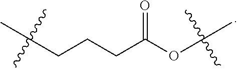 [SMILES: *CCCC(=O)O*]

In a certain embodiment, the disclosure provides a dynamic crosslinker that inserts into C—H groups of a polymer that has the structure of:

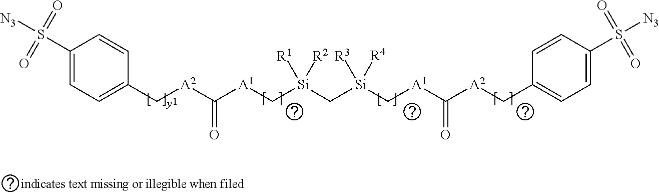

wherein, x¹ is an integer selected from 0, 1, 2, and 3; y¹ is an integer selected from 0, 1, 2, and 3; z¹ is an integer selected from 1, 2, and 3; A¹ is selected from CR⁵R⁶, NR⁷, O,

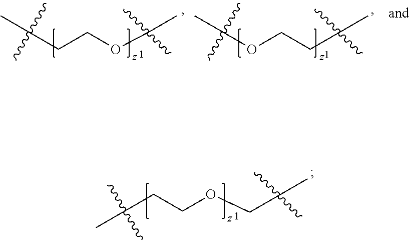

A² is selected from CR⁸R⁹, NR¹⁰, and O; R¹-R⁴ are each individually selected from a (C₁-C₆)alkyl group and an aryl; and R¹-R¹⁰ are each individually selected from H, D, optionally substituted (C₁-C₆)alkyl, optionally substituted (C₁-C₆)alkenyl, optionally substituted (C₁-C₆)alkynyl, optionally substituted aryl, optionally substituted cycloalkyl, optionally substituted heterocycle, halo, cyano, (C₁-C₅)alkoxy, thiol, sulfide, hydroxyl, aldehyde, carboxylic acid, amine, amide, (C₁-C₆)ketone, and (C₁-C₅)ester. In a further embodiment, the disclosure provides a dynamic crosslinker that inserts into C—H groups of a polymer that has the structure of:

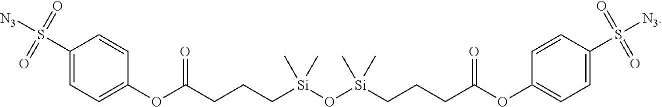 [SMILES: C[Si](C)(CCCC(=O)Oc1ccc(S(=O)(=O)N=[N+]=[N-])cc1)O[Si](C)(C)CCCC(=O)Oc1ccc(S(=O)(=O)N=[N+]=[N-])cc1]

In a certain embodiment, the disclosure also provides for polymers that have been crosslinked with a dynamic crosslinker of the disclosure. In a particular embodiment, the disclosure provides for a polymer or mixture of polymers comprising crosslinks having the structure of:

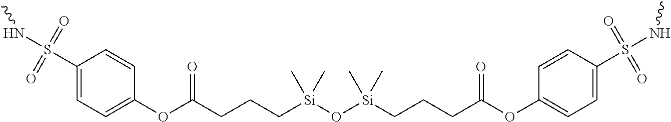

The dynamic crosslinker of the disclosure has been designed to insert into C—H bonds of a diverse array of polymers. In particular, it was found that the terminal ASA groups of the dynamic polymer generated a highly reactive singlet nitrene species that was capable of inserting into almost any C—H bond of a diverse array of polymers to induce dynamic crosslinking. Notably, the nitrene system exhibits a distinct advantage over the carbene analog as ASA decomposes at a significantly higher temperature in creating nitrene species (peak decomposition at ˜190° C. for ASA, compared to ˜138° C. for diazirine), rendering it suitable for the typical melt processing of numerous commodity plastics. Commodity plastics or commodity polymers are plastics produced in high volumes for applications such as packaging, food containers, and household products, including both disposable products and durable goods. In contrast to engineering plastics, commodity plastics tend to be inexpensive to produce and exhibit relatively weak mechanical properties. Widely used commodity plastics include, but are not limited to, polyethylene (PE), high-density polyethylene (HDPE), low-density polyethylene (LDPE), polypropylene (PP), isotactic polypropylene (iPP), polystyrene (PS), polyvinyl chloride (PVC), poly(methyl methacrylate) (PMMA), polyethylene terephthalate (PET), and polyethylene terephthalate glycol (PETg). Products made from commodity plastics include disposable plates, disposable cups, photographic and magnetic tape, clothing, reusable bags, medical trays, and seeding trays. It should be noted that the dynamic crosslinker is not limited to promoting crosslinking in commodity plastics, as the dynamic crosslinker can promote crosslinking in most types of polymers that have C—H bonds.

The disclosure also provides processes for introducing dynamic crosslinks into one or more polymers using a dynamic crosslinker disclosed herein. For example, a process for introducing dynamic crosslinks into one or more polymers, comprises: introducing dynamic crosslinks into a polymer by reacting one or more polymers at an elevated temperature with a dynamic crosslinker of the disclosure. In particular, the reaction is carried out at a sufficient temperature to melt the polymer and to thermally decompose the ASA groups of the dynamic crosslinker. In a certain embodiment, the reaction is carried out by solvent-free melt extrusion at 140-260° C. using an extruder. In a further embodiment, the extruder is a twin-screw extruder. In yet a further embodiment, the solvent-free melt extrusion has a reactive extrusion residence time from 5 to 20 minutes. As noted above, the dynamic crosslinker of the disclosure can promote crosslinking in most types of polymers that have C—H bonds. For example, the disclosure provides for introducing dynamic crosslinks into a commodity plastic by reacting the commodity plastic at an elevated temperature with a dynamic crosslinker of the disclosure. Examples of commodity plastics include, but are not limited to, polyethylene (PE), high-density polyethylene (HDPE), low-density polyethylene (LDPE), polypropylene (PP), isotactic polypropylene (iPP), polystyrene (PS), polyvinyl chloride (PVC), poly(methyl methacrylate) (PMMA), polyethylene terephthalate (PET), and polyethylene terephthalate glycol (PETg). In a particular embodiment, the commodity plastic is selected from HDPE, LDPE, iPP, PS, and PETg. It was found herein that reactions using the dynamic crosslinker of the disclosure provided for crosslinked plastics with thermoset performance and thermoset recyclability. Moreover, it was found that processes for introducing dynamic crosslinks into one or more polymers using a dynamic crosslinker disclosed herein provided for compatibilization of binary polymer blends through dynamic crosslinking.

It is expected that the dynamic crosslinker of the disclosure can be used in a variety of applications. The inherent incompatibility of polymers presents a fundamental challenge in creating polymer blends and recycling mixed plastic waste. Conventional compatibilization methods, including nonreactive and reactive approaches, require tailored designs specific to the chemical compositions of the polymers. This customized approach not only hinders the advancement of innovative polymer blends, but also becomes impractical for the compatibilization of mixed plastics waste due to its complex nature. Such waste typically comprises a mixture of polar and nonpolar polymers with ever changing compositions. The results with the dynamic crosslinker of the disclosure indicate that the dynamic crosslinker disclosed herein can be applied to compatibilize mixed plastic waste using a solvent-free melt-extrusion process, promising a practical solution for the mechanical recycling of mixed plastic waste.

For use in applications described herein, articles of manufacture or kits are also described herein. Such articles of manufacture or kits can comprise a carrier, package, or container that is compartmentalized to receive one or more containers, each of the container(s) comprising a dynamic crosslinker disclosed herein to be used in a method or application described herein. Suitable containers include, for example, tanks, carboys, drums, bottles, vials, syringes, and test tubes. The containers can be formed from a variety of materials such as glass or plastic. Such articles of manufacture or kits can optionally comprise an identifying description or label or instructions relating to its use in a method described herein.

An article of manufacture or kit can comprise one or more additional containers, each with one or more of various materials (such as reagents, optionally in concentrated form, and/or devices) desirable from a commercial and user standpoint for use of a viscoelastic material described herein. Non-limiting examples of such materials include, but are not limited to, buffers, diluents, filters and/or labels listing contents and/or instructions for use, and package inserts with instructions for use. A set of instructions will also typically be included.

A label can be on or associated with the container. A label can be on a container when letters, numbers or other characters forming the label are attached, molded or etched into the container itself; a label can be associated with a container when it is present within a receptacle or carrier that also holds the container, e.g., as a package insert. A label can be used to indicate that the contents are to be used for a specific application. The label can also indicate directions for use of the contents, such as in the methods described herein.

The disclosure further provides that the methods and compositions described herein can be further defined by the following aspects (aspects 1 to 25):

1. A dynamic crosslinker that inserts into C—H groups of a polymer or a mixture of polymers, comprising:
a siloxane group;
a plurality of terminal aromatic sulfonyl azide (ASA) groups; and
a plurality of linking groups that connect the terminal ASA groups to the siloxane group,
wherein the crosslinker inserts into C—H groups of a polymer or a mixture of polymers upon decomposition of the ASA groups,
particularly, the siloxane group is a single, centrally located siloxane group,
particularly, the plurality of terminal ASA groups have the same structure, more particularly, the plurality terminal ASA groups comprise 2, 3, or 4 ASA groups that have the same structure,
particularly, the dynamic crosslinker comprises the same number of linking groups as ASA groups, more particularly, the dynamic crosslinker comprises 2 linking groups and 2 terminal ASA groups,
particularly, the decomposition of the ASA groups is thermal decomposition or photodecomposition, more particularly, the decomposition of the ASA groups is thermal decomposition, yet more particularly, the decomposition of the ASA groups is thermal decomposition by heating the dynamic crosslinker at a temperature from 140 to 260° C., yet more particularly, the decomposition of the ASA groups is thermal decomposition by heating the dynamic crosslinker at a temperature from 180 to 200° C.

2. The dynamic crosslinker of aspect 1, wherein decomposition of the ASA groups generates a nitrene intermediate,
particularly, the nitrene intermediate is a singlet nitrene intermediate,
particularly, the decomposition of the ASA groups is thermal decomposition or photodecomposition, more particularly, the decomposition of the ASA groups is thermal decomposition.

3. The dynamic crosslinker of aspect 1 or aspect 2, wherein the polymer or mixtures of polymers comprises synthetic polymer(s), semi-synthetic polymer(s) and/or organic polymer(s),
particularly, the mixtures of polymers comprise synthetic polymer(s) and/or semi-synthetic polymer(s), more particularly, the mixtures of polymers comprise commodity plastics, yet more particularly, the mixtures of polymers comprise commodity plastics selected from polyethylene (PE), high-density polyethylene (HDPE), low-density polyethylene (LDPE), polypropylene (PP), isotactic polypropylene (iPP), polystyrene (PS), polyvinyl chloride (PVC), poly(methyl methacrylate) (PMMA), polyethylene terephthalate (PET), and polyethylene terephthalate glycol (PETg).

4. The dynamic crosslinker of any one of the preceding aspects, wherein the polymer or mixtures of polymers comprises polymers of cellulose, lignin, hyaluronic acid, chitosan, alginate, polyethylene (PE), polyethylene terephthalate (PET), poly carbonate (PC), high-density polyethylene (HDPE), low-density polyethylene (LDPE), polypropylene (PP), isotactic polypropylene (iPP), polystyrene (PS), polyvinyl chloride (PVC), poly(methyl methacrylate) (PMMA), polyethylene terephthalate (PET), Acrylonitrile Butadiene Styrene (ABS), polyoxymethylene (POM), polyamide (PA), thermoplastic polyurethane (TPU), thermoplastic elastomers (TPE) and/or polyethylene terephthalate glycol (PETg).

5. The dynamic crosslinker of any one of the preceding aspects, wherein the siloxane group has the structure of:

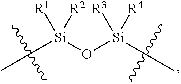

wherein,
R¹-R⁴ are each individually selected from a (C₁-C₆)alkyl group and an aryl,
   particularly, R¹-R⁴ are each individually selected from a methyl, an ethyl, a propyl, a butyl and a phenyl group.

6. The dynamic crosslinker of any one of the preceding aspects, wherein the siloxane group has the structure of:

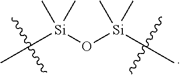 [SMILES: *[Si](C)(C)O[Si](*)(C)C]

7. The dynamic crosslinker of any one of the preceding aspects, wherein the dynamic crosslinker has from 2 to 10 terminal ASA groups,
particularly, the dynamic crosslinker has from 2 to 4 terminal ASA groups, more particularly, the dynamic crosslinker has 2 or 3 terminal ASA groups.

8. The dynamic crosslinker of any one of the preceding aspects, wherein the plurality of terminal ASA groups have the structure of:

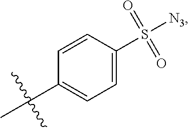 [SMILES: *c1ccc(S(=O)(=O)N=[N+]=[N-])cc1]

particularly, the dynamic crosslinker has 2 or 3 terminal ASA groups having the structure of:

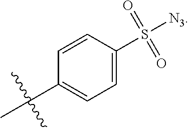 [SMILES: *c1ccc(S(=O)(=O)N=[N+]=[N-])cc1]

9. The dynamic crosslinker of any one of the preceding aspects, wherein the plurality of linking groups have the structure of:

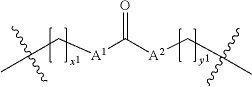

wherein,
x¹ is an integer selected from 0, 1, 2, and 3;
y¹ is an integer selected from 0, 1, 2, and 3;
z¹ is an integer selected from 1, 2, and 3; A¹ is selected from CR⁵R⁶, NR⁷, O,

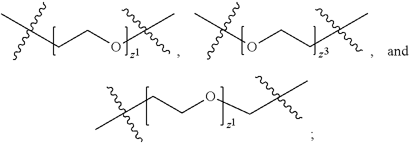

A² is selected from CR⁸R⁹, NR¹⁰, and O; and
R⁵-R¹⁰ are each individually selected from H, D, optionally substituted (C₁-C₆)alkyl, optionally substituted (C₁-C₆)alkenyl, optionally substituted (C₁-C₆)alkynyl, optionally substituted aryl, optionally substituted cycloalkyl, optionally substituted heterocycle, halo, cyano, (C₁-C₅)alkoxy, thiol, sulfide, hydroxyl, aldehyde, carboxylic acid, amine, amide, (C₁-C₆)ketone, and (C₁-C₅)ester.

10. The dynamic crosslinker of any one of the preceding aspects, wherein the plurality of linking groups have a structure selected from:

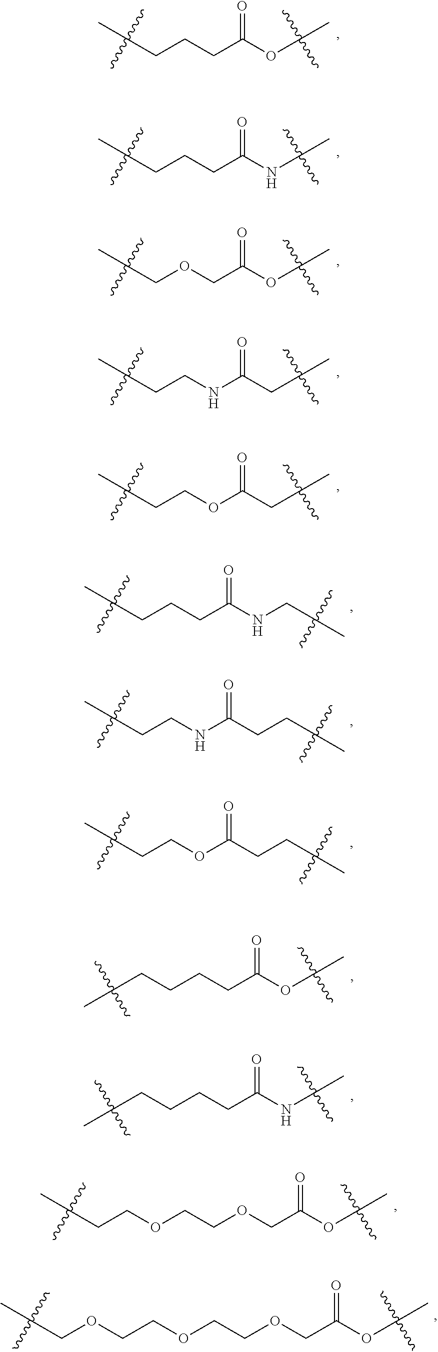

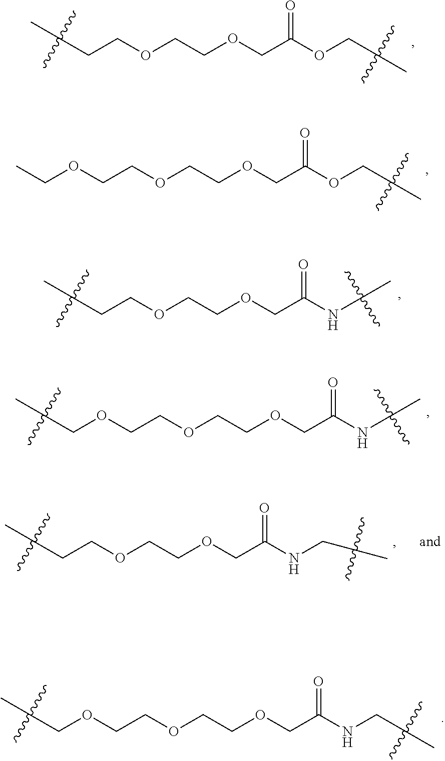 [SMILES: *CCOCCOCC(=O)OC* ; *COC(=O)COCCOCCOCC ; *CCOCCOCC(=O)N* ; *COCCOCCOCC(=O)N* ; *CCOCCOCC(=O)NC* ; *CNC(=O)COCCOCCOC*]

11. The dynamic crosslinker of any one of the preceding aspects, wherein a plurality of linking groups have the structure of:

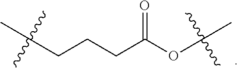 [SMILES: *CCCC(=O)O*]

12. The dynamic crosslinker of any one of the preceding aspects, wherein the crosslinker is a bis-ASA crosslinker having the structure of:

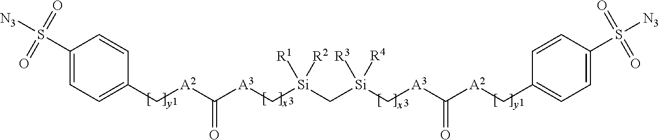

wherein,
x¹ is an integer selected from 0, 1, 2, and 3;
y is an integer selected from 0, 1, 2, and 3;
z is an integer selected from 1, 2, and 3;
A¹ is selected from CR⁵R⁶, NR⁷, O,

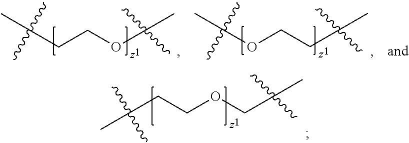

A² is selected from CR⁸R⁹, NR¹⁰, and O;
R¹-R⁴ are each individually selected from a (C₁-C₆)alkyl group and an aryl; and
R⁵-R¹⁰ are each individually selected from H, D, optionally substituted (C₁-C₆)alkyl, optionally substituted (C₁-C₆)alkenyl, optionally substituted (C₁-C₆)alkynyl, optionally substituted aryl, optionally substituted cycloalkyl, optionally substituted heterocycle, halo, cyano, (C₁-C₅)alkoxy, thiol, sulfide, hydroxyl, aldehyde, carboxylic acid, amine, amide, (C₁-C₆)ketone, and (C₁-C₅)ester.

13. The dynamic crosslinker of any one of the preceding aspects, wherein the dynamic crosslinker is a bis-ASA crosslinker having the structure of:

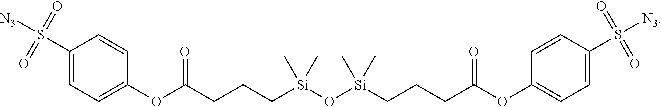 [SMILES: C[Si](C)(CCCC(=O)Oc1ccc(S(=O)(=O)N=[N+]=[N-])cc1)O[Si](C)(C)CCCC(=O)Oc1ccc(S(=O)(=O)N=[N+]=[N-])cc1]

14. A crosslinked polymer or mixture of crosslinked polymers comprising crosslinks having the structure of:

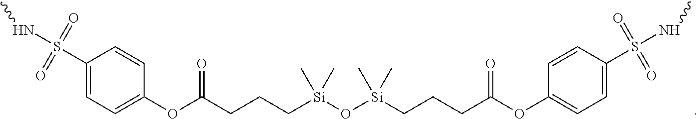

15. The crosslinked polymer or mixture of crosslinked polymers of aspect 14, wherein the crosslinked polymer or mixture of crosslinked polymers comprise organic polymer(s), semi-synthetic polymer(s), and/or synthetic polymer(s).

16. The crosslinked polymer or mixture of crosslinked polymers of aspect 14 or aspect 15, wherein the crosslinked polymer or mixture of crosslinked polymers comprise polymers of cellulose, lignin, hyaluronic acid, chitosan, alginate, polyethylene (PE), polyethylene terephthalate (PET), poly carbonate (PC), high-density polyethylene (HDPE), low-density polyethylene (LDPE), polypropylene (PP), isotactic polypropylene (iPP), polystyrene (PS), polyvinyl chloride (PVC), poly(methyl methacrylate) (PMMA), polyethylene terephthalate (PET), Acrylonitrile Butadiene Styrene (ABS), polyoxymethylene (POM), polyamide (PA), thermoplastic polyurethane (TPU), thermoplastic elastomers (TPE) and/or polyethylene terephthalate glycol (PETg),
particularly, the mixtures of polymers comprise commodity plastics,
yet more particularly, the mixtures of polymers comprise commodity plastics selected from polyethylene (PE), high-density polyethylene (HDPE), low-density polyethylene (LDPE), polypropylene (PP), isotactic polypropylene (iPP), polystyrene (PS), polyvinyl chloride (PVC), poly(methyl methacrylate) (PMMA), polyethylene terephthalate (PET), and polyethylene terephthalate glycol (PETg).

17. A process for introducing dynamic crosslinks into a polymer or a mixture of polymers, comprising:
introducing dynamic crosslinks into a polymer or mixture of polymers by reacting one or more polymers with the dynamic crosslinker of any one of aspects 1 to 13 at an elevated temperature or under light irradiation to decompose the ASA groups of the dynamic crosslinker.

18. The process of aspect 17, wherein the reaction is carried out using an extruder in a solvent-free melt extrusion process at 140° C., 150° C., 160° C., 170° C., 180° C., 190° C., 200° C., 210° C., 220° C., 230° C., 240° C., 250° C., or 260° C., or a range that includes or is between any two of the foregoing temperatures (e.g., 140° C. to 260° C., 180° C. to 200° C., etc.),
particularly, in a solvent-free melt extrusion process at 180-260° C.,
more particularly, in a solvent-free melt extrusion process at 180-200° C.

19. The process of aspect 17 or aspect 18, wherein the reaction is carried out in the presence of a catalyst,
particularly, a fluoride catalyst, more particularly a fluoride catalyst selected from potassium fluoride:dibenzo-18-crown-6 and tetrabutylammonium fluoride trihydrate.

20. The process of aspect 17, wherein the reaction is carried out under UV light irradiation.

21. The process of any one of aspects 17 to 20, wherein the polymer or mixtures of polymers comprises synthetic polymer(s), semi-synthetic polymer(s) and/or organic polymer(s).

22. The process of any one of aspects 17 to 21, wherein the polymer or mixtures of polymers comprises polymers of cellulose, lignin, hyaluronic acid, chitosan, alginate, polyethylene (PE), polyethylene terephthalate (PET), poly carbonate (PC), high-density polyethylene (HDPE), low-density polyethylene (LDPE), polypropylene (PP), isotactic polypropylene (iPP), polystyrene (PS), polyvinyl chloride (PVC), poly(methyl methacrylate) (PMMA), polyethylene terephthalate (PET), Acrylonitrile Butadiene Styrene (ABS), polyoxymethylene (POM), polyamide (PA), thermoplastic polyurethane (TPU), thermoplastic elastomers (TPE) and/or polyethylene terephthalate glycol (PETg).

23. The process of any one of aspects 17 to 22, wherein the mixtures of polymers comprise commodity plastics,
particularly the mixtures of polymers comprise commodity plastics selected from polyethylene (PE), high-density polyethylene (HDPE), low-density polyethylene (LDPE), polypropylene (PP), isotactic polypropylene (iPP), polystyrene (PS), polyvinyl chloride (PVC), poly(methyl methacrylate) (PMMA), polyethylene terephthalate (PET), and polyethylene terephthalate glycol (PETg).

24. The process of any one of aspects 17 to 23, wherein dynamic crosslinking of the polymer or mixtures of polymers using the dynamic crosslinker provides for crosslinked polymers with thermoset performance and recyclability.

25. The process aspect 24, wherein the polymer or mixtures of polymers is mixed plastic waste, and the crosslinked plastic waste is recyclable.

The following examples are intended to illustrate but not limit the disclosure. While they are typical of those that might be used, other procedures known to those skilled in the art may alternatively be used.

### EXAMPLES

The invention is illustrated in the following examples, which are provided by way of illustration and are not intended to be limiting.

General experimental information. Unless stated otherwise, all reactions were performed with anhydrous solvents and a magnetic stir bar. Commercial reagents were used without further purification. A Bruker DRX500 was used to collect ¹H NMR spectra at 500 MHz, whereas ¹³C spectra were recorded with a Bruker DRX500 or AVANCE600 with a BBFO cryoprobe at 125 MHz and 151 MHz, respectively. ¹H¹H 2D COSY spectra were gathered using an AVANCE600. Various spectra peaks were reported as δ values in ppm relative to TMS or residual solvent: CDCl₃ (¹H=7.26 ppm; ¹³C=77.0 ppm), DMSO (¹H=2.50 ppm; ¹³C=39.5 ppm), d2-tetrachloroethane (¹H=6.00 ppm). For ¹H NMR spectra, the chemical shift in ppm, multiplicity (s=singlet, d=doublet, t=triplet, m=multiplet), relative integration of the number of protons, and coupling values are reported. For ¹³C NMR, only the chemical shift in ppm is reported. Mass spectrometry was performed on a Waters Acquity UPLC H-Class equipped with an Acquity QDa Detector. Extrusion was performed on a Thermo Haake Minilab II conical twin screw extruder with 7 cm³ volume under nitrogen flow. Scanning electron microscopy (SEM) micrographs were taken on a FEI Magellan 400

XHR SEM. Rheological measurements (creep tests, stress relaxation measurements, and frequency sweeps) were taken using a TA Instruments DHR-2 Rheometer. Dynamic Mechanical Thermal Analysis (DMTA) was performed on a TA Instruments Q800. Uniaxial tensile tests were carried out on an Instron 3365 mechanical tester fitted with pneumatic grips. Differential Scanning Calorimetry (DSC) thermograms were obtained with a TA Instruments DSC2500. Thermogravimetric Analysis (TGA) thermograms were recorded using a TA Instruments Q500 or a Netzsch STA 449 F3 Jupiter.

Chemicals and materials. High density polyethylene (HDPE, melt index 2.2 g/10 min at 190° C. with a 2.16 kg load, Sigma-Aldrich), low density polyethylene (LDPE, melt index 1.5 g/10 min at 190° C. with a 2.16 kg load, Sigma-Aldrich), isotactic polypropylene (iPP, Mn=97,000, Mw=340,000 g/mol, melt index 4 g/10 min at 230° C. with a 2.16 kg load, Sigma-Aldrich), polystyrene (PS, Mw=192,000, melt index of 6.0-9.0 g/10 min at 200° C. with a 5 kg load, Sigma-Aldrich), and polyethylene terephthalate glycol (PETg, melt flow rate 28 g/10 min at 220° C. with a 10 kg load, Smart Materials 3D) were milled into a fine powder using a Fritsch Pulverisette rotary mill fitted with a 0.5 mm sieve cassette. The commodity plastics used for the model mixed plastic compatibilization studies are: HDPE (wide-mouth bottle from Nalgene™) LDPE (commercial food bags from Ziploc®), iPP (clothes hangers from Room Essentials™ and drinking straws from up&up™), PS (food dish from Party Essentials™), and PETg (medical media bottles from Chemglass Inc.). The following reagents were used as received: dibenzo-18-crown-6 (99%, TCI America), potassium fluoride (99%, Sigma-Aldrich), sodium 4-hydroxybenzenesulfonate dihydrate (98%, Sigma-Aldrich), oxalyl chloride (98%, TCI America), N,N-dimethylformamide (ACS grade, Macron Fine Chemicals), sodium azide (99%, Fisher Scientific), 1-(3-dimethylaminopropyl)-3-ethylcarbodiimide hydrochloride (Advanced Chemtech), 4-dimethylaminopyridine (99%, Alfa Aesar), 1,3-bis(3-carboxypropyl)tetramethyldisiloxane (97%, Aaron Chemicals), cyclohexane (ACS grade, Millipore Sigma), 2,4-dimethylpentane (99%, Sigma-Aldrich), tetrabutylammonium fluoride trihydrate (98%, Oakwood Chemical), butylated hydroxytoluene (99%, Sigma-Aldrich). Solvents were purchased commercially.

### Small Molecule Synthesis and Model Reaction Studies.

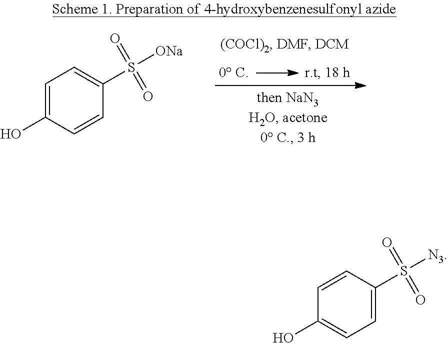

Sodium 4-hydroxybenezenesulfonate dihydrate (1 equiv., 12.946 mmol, 3.0058 g) was dissolved in 15 mL of N,N-dimethylformamide (DMF) before slowly transferring it to a round-bottom flask in an ice bath containing 54 mL of dichloromethane (DCM) and oxalyl chloride (6 equiv., 77.7 mmol, 6.66 mL). The solution was allowed to warm to r.t. with stirring for 16 h, after which it was poured into 150 mL of ice and transferred to a separatory funnel. The organic layer was washed thrice with 100 mL brine, dried over sodium sulfate, and the solvent was removed in vacuo. The oil was redissolved in 20 mL of acetone, introduced to an ice bath, and then sodium azide (1.11 equiv., 14.3 mmol, 932 mg) in 9.5 mL of water was transferred to the flask dropwise via syringe, and allowed to stir for 3 h. Next, 70 mL of ethyl acetate (EtOAc) was used to dilute the reaction mixture before subsequent extractions with 150 mL water and brine. The organic layer was dried over sodium sulfate and concentrated in vacuo to yield a pale orange oil. Characterization was in excellent agreement with previous reports of 4-hydroxybenzenesulfonyl azide. Yield: 2.082 g, 81%.

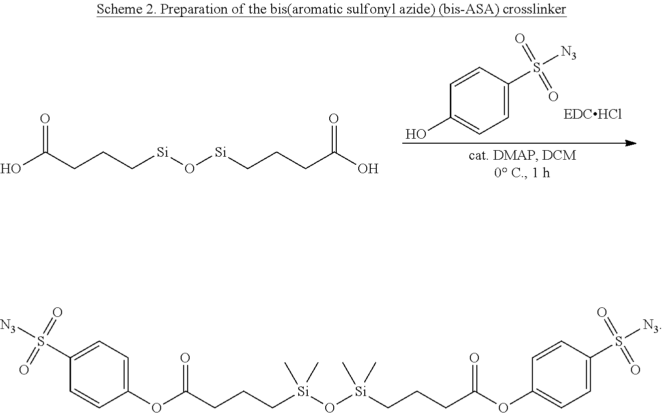

To a round-bottom flask containing 1,3-bis(3-carboxypropyl)tetramethyldisiloxane (1 equiv., 6.0354 mmol, 1.8499 g), 4-hydroxybenzenesulfonyl azide (2.05 equiv., 12.4 mmol, 2.46 g), and 4-dimethylaminopyridine (DMAP, 0.301 equiv., 1.82 mmol, 0.222 g) was added 50 mL of DCM. The reaction flask was placed in an ice bath and allowed to equilibrate with stirring until the reagents completely dissolved. Then, 1-(3-dimethylaminopropyl)-3-ethylcarbodiimide hydrochloride (EDC·HCl, 3.026 equiv., 18.26 mmol, 3.501 g) was added and the reaction was allowed to stir for 1 h before dilution with 200 mL of EtOAc and subsequent extractions with 300 mL of saturated sodium bicarbonate, 1 M HCl, and brine. The organic layer was dried over sodium sulfate and purified though solid loading flash chromatography (Teledyne Isco® CombiFlash+) with 80:20 hexanes (Hex) to EtOAc. The purified compound was placed in a refrigerator overnight to yield a white flaky solid. The flakes were ground with a mortar and pestle before use. Yield: 2.433 g, 60%.

bis-ASA crosslinker. ¹H NMR (500 MHz, CDCl₃, 298 K) δ 7.98 (d, 4H), 7.35 (d, 4H), 2.63 (t, J=7.3 Hz, 4H), 1.80 (dtd, J=12.3, 7.3, 5.1 Hz, 4H), 0.69-0.61 (m, 4H), 0.15-0.06 (m, 12H). ¹³C NMR (125 MHz, CDCl₃, 298 K) δ 171.17, 155.75, 135.64, 129.45, 123.12, 37.70, 19.13, 18.11, 0.47. ESI-MS calcd. for C₂₄H₃₂N₆O₉S₂Si₂, [M+Na]⁺=691.1 m/z, found 691.1 m/z.

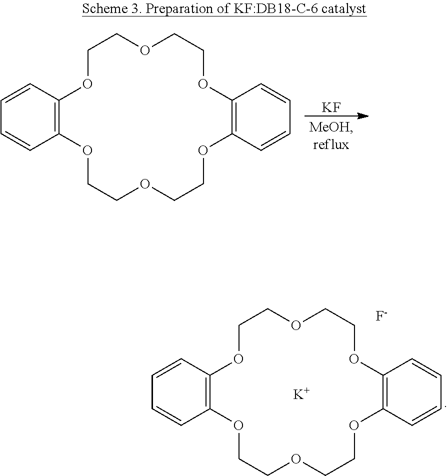

The KF:DB18-C-6 catalyst was prepared using dibenzo-18-crown-6 (1 equiv., 5.552 mmol, 2.001 g) and KF (1.01 equiv., 5.61 mmol, 0.326 g) with identical conditions as described in Tretbar et al., “Fluoride-Catalyzed Siloxane Exchange as a Robust Dynamic Chemistry for High-Performance Vitrimers.” Adv. Mater 35(28):2303280 (2023). Yield: 1.667 g, 71%.

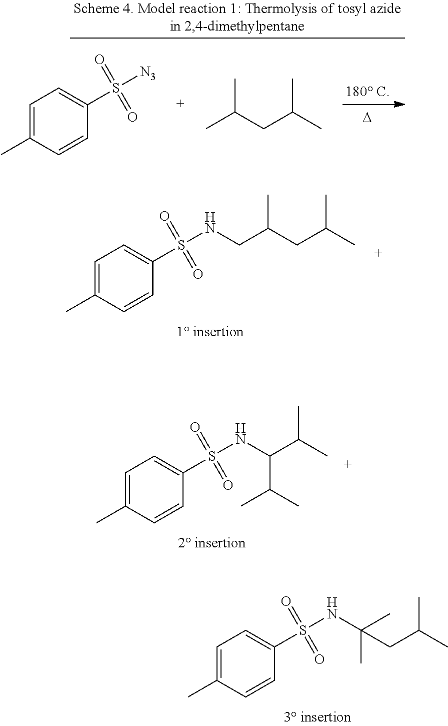

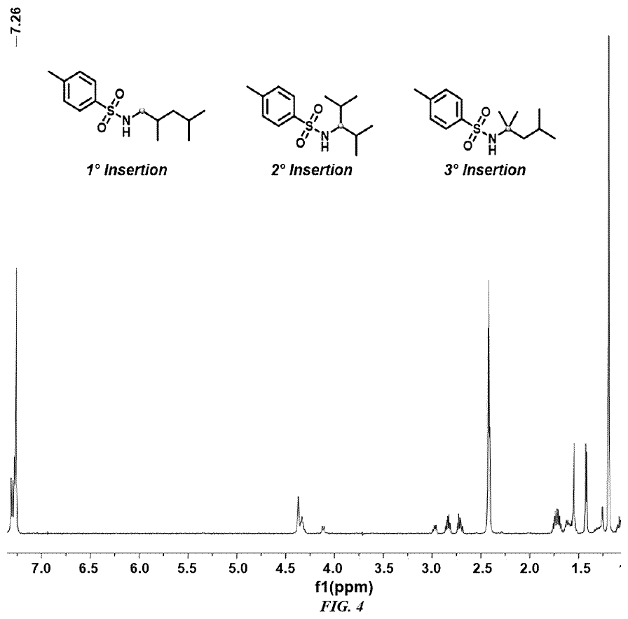

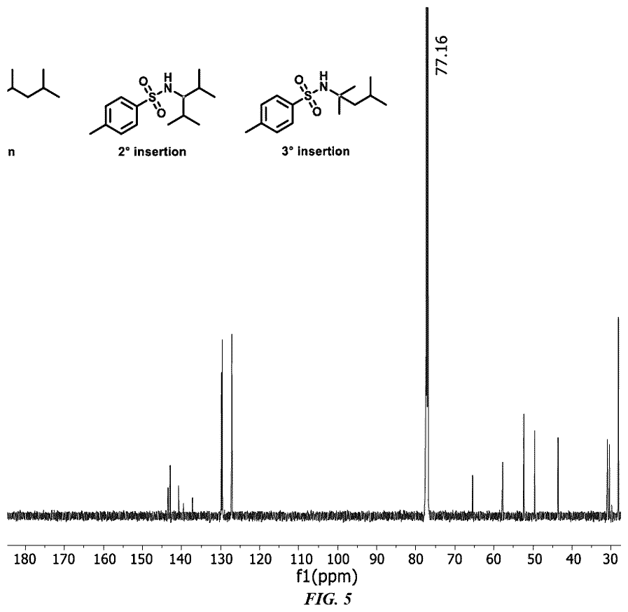

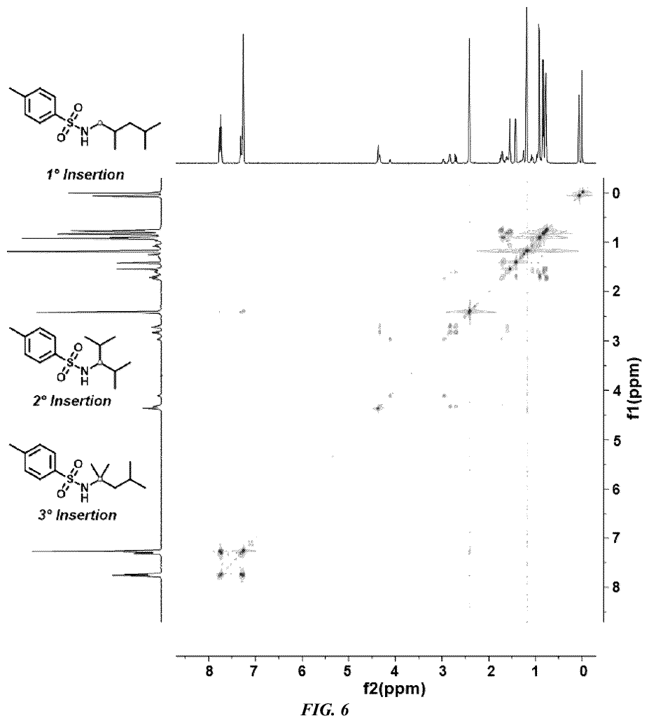

To a 15 mL pressure tube was added tosyl azide (1 equiv. 91 mol, 18 mg) and 2,4-dimethylpentane (610. Equiv. 55.7 mmol, 8.00 mL) before it was securely sealed under a blanket of nitrogen gas. The reaction vessel was heated to 180° C. for 1 h with a bomb shield in place. Then, it was removed from heating and allowed to cool to r.t. before it was concentrated in vacuo. The reaction mixture was purified by preparatory thin-layer chromatography with 70:30 DCM to Hex to yield the regioisomeric mixture from a streaking fraction. The 1D ¹H NMR, ¹³C NMR, and ¹H¹H 2D COSY spectra of the regioisomeric mixture are shown in FIGS. 4, 5, and 6, respectively. The ESI-MS data is in agreement with the formation of tosyl nitrene adduct with 2,4-dimethylpentane: ESIMS calcd. For C₁₄H₂₂NO₂S, [M−H]⁻=268.1 m/z, found 267.9 m/z.

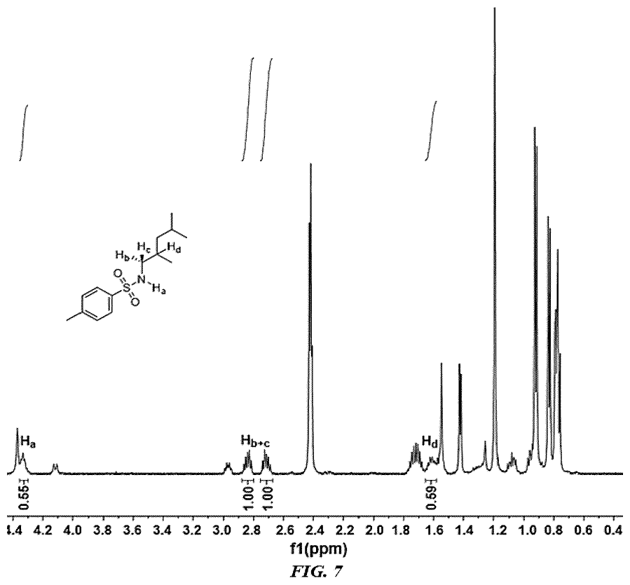

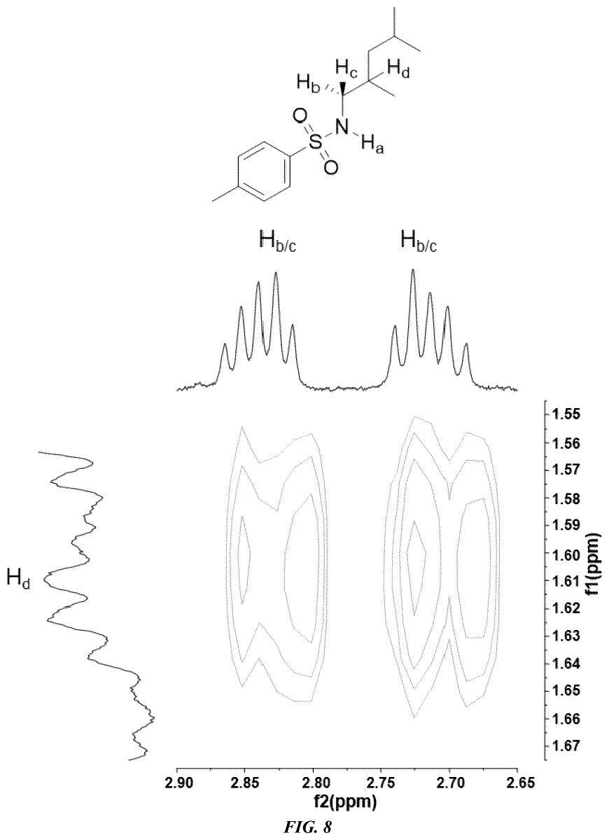

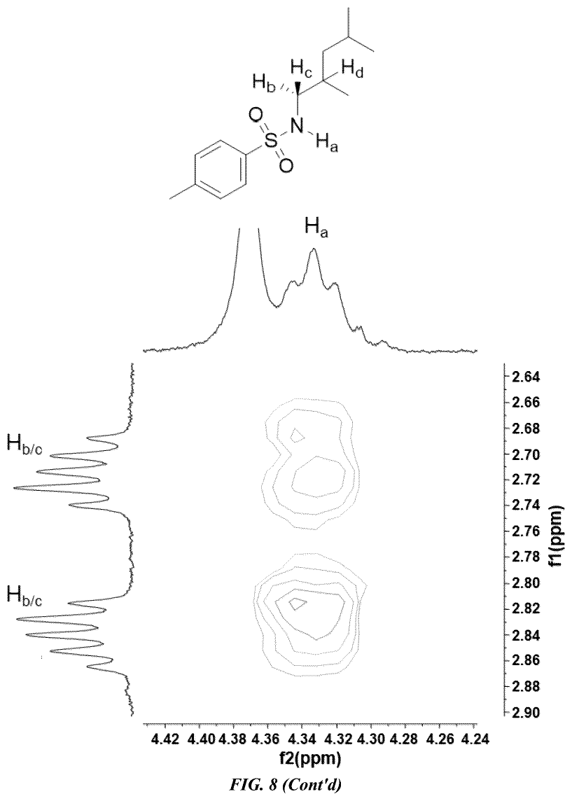

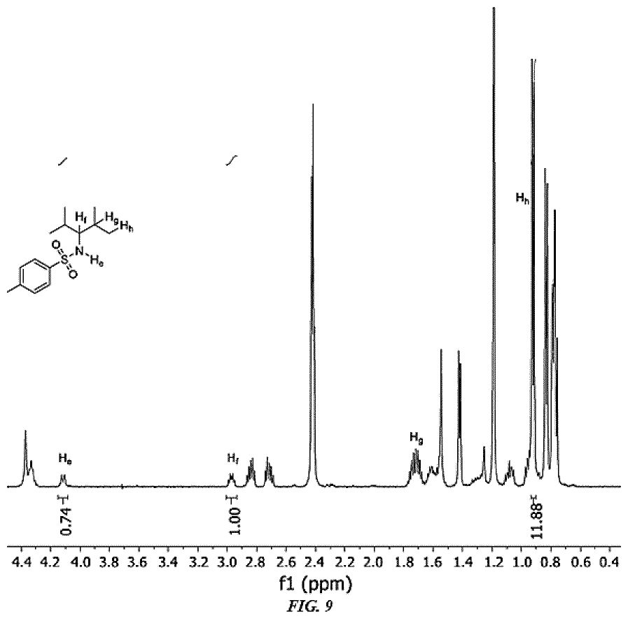

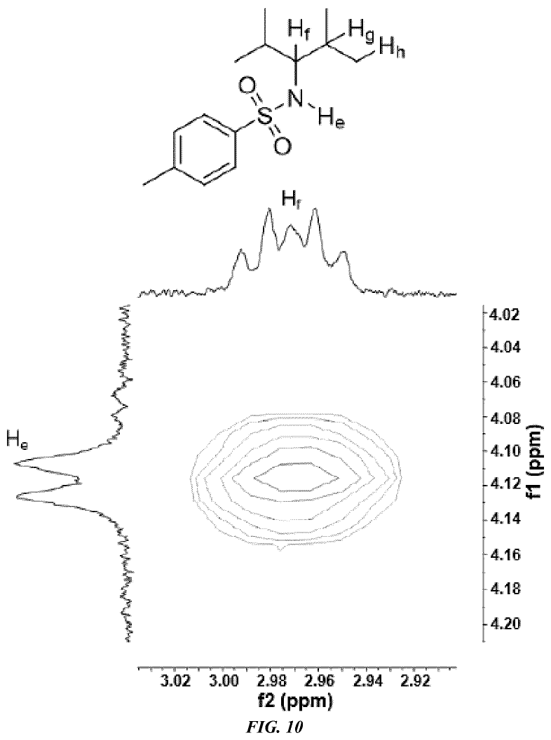

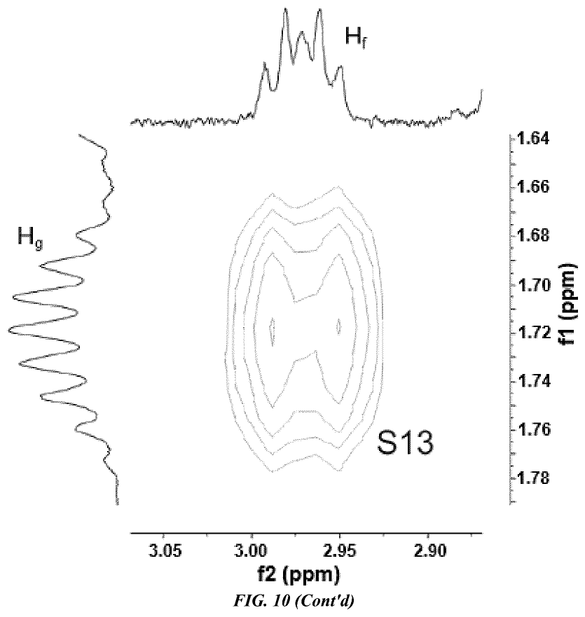

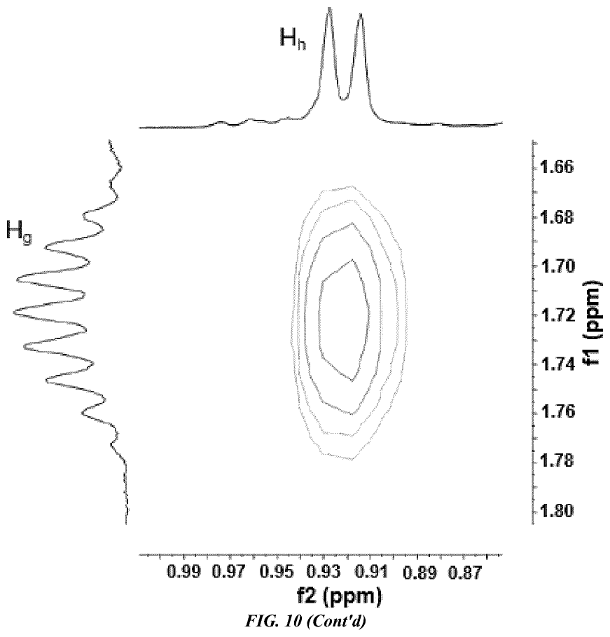

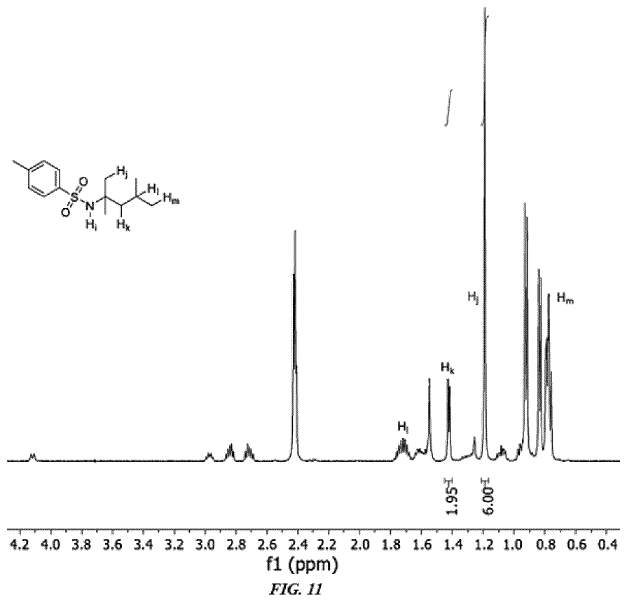

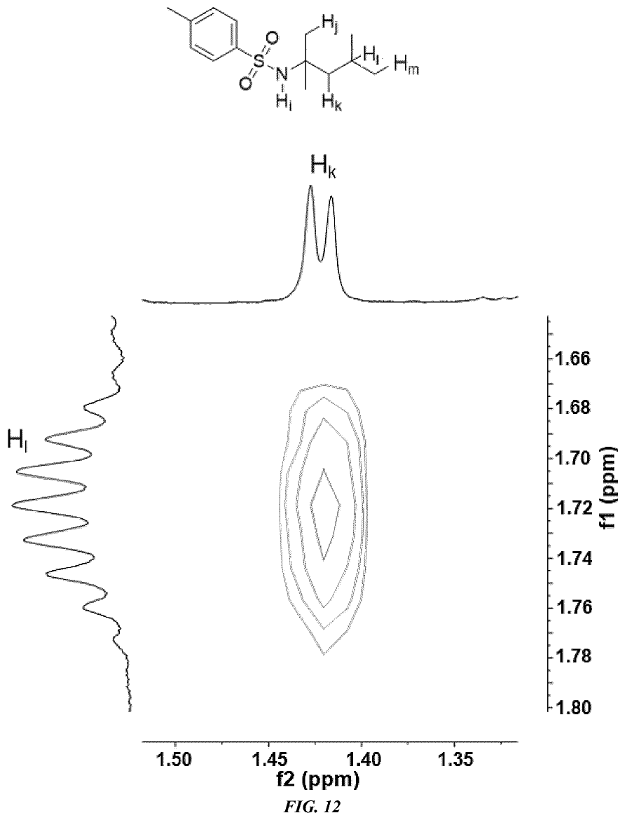

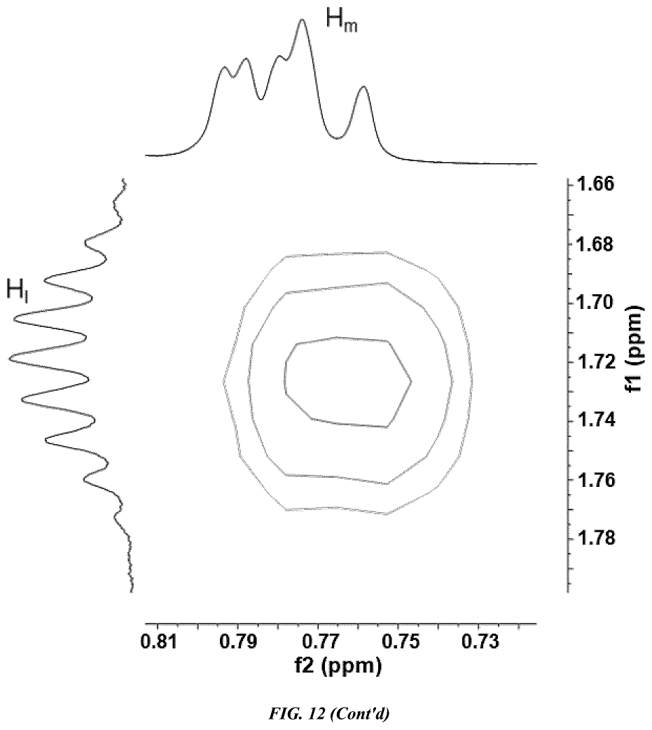

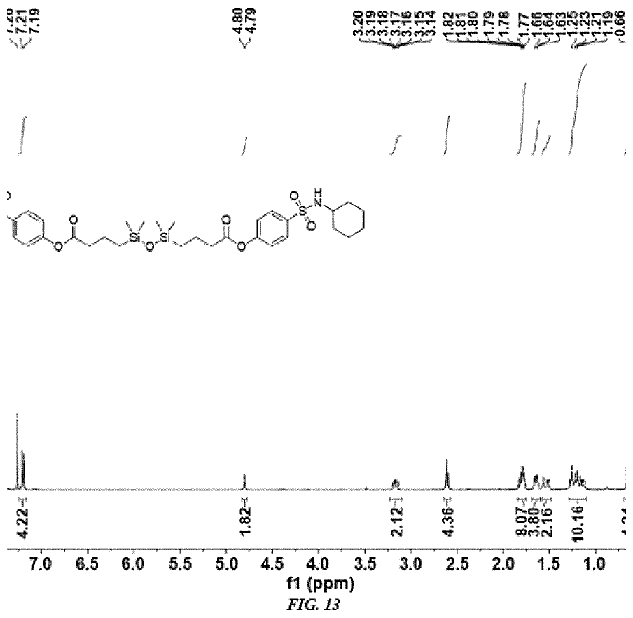

The assignments of key ¹H NMR peaks corresponding to the primary, secondary, and tertiary C—H insertion products in the regioisomeric mixture were made through a combination of chemical shift values, J-J coupling patterns, and ¹H¹H correlations on 2D COSY spectra (see FIGS. 7-12). Key regions of the 2D COSY spectrum are magnified to highlight the essential cross peaks for ¹H¹H correlations (see FIGS. 8, 10, and 12). To calculate the reactivity ratio, the integration of each diastereotopic proton of the primary insertion product was calibrated to 1.00. Then the integration of the secondary insertion product methine (Hf) and that of the tertiary insertion product methyl (Hj) were found to be 0.57 and 7.96, respectively. Next, the integrations were normalized based on the number of protons corresponding to each signal and divided by the number of C—H bonds that could yield a specific product (12 C—H bonds on primary methyl groups, 2 C—H bonds on the secondary methylene group, and 2 C—H bonds on the tertiary methines in 2,4-dimethylpentane). The resulting value was normalized by the lowest represented product to find the reactivity ratio.
1°: 1.00 int/1H=1.00 int/H (1.00 int/H)/12 possible primary C—H bonds=0.0833 0.0833/0.0833=1.0 reactivity ratio
2°: 0.57 int/1H=0.57 int/H (0.57 int/H)/2 possible secondary C—H bonds=0.285 0.285/0.0833=3.4 reactivity ratio
3°: 7.96 int/6H=1.33 int/H (1.33 int/H)/2 possible tertiary C—H bonds=0.663 0.663/0.08333=8.0 reactivity ratio

Therefore, the overall reactivity ratio for insertion of the singlet nitrene into primary, secondary, and tertiary C—H bonds in 2,4-dimethylpentane is 1:3.4:8.0.

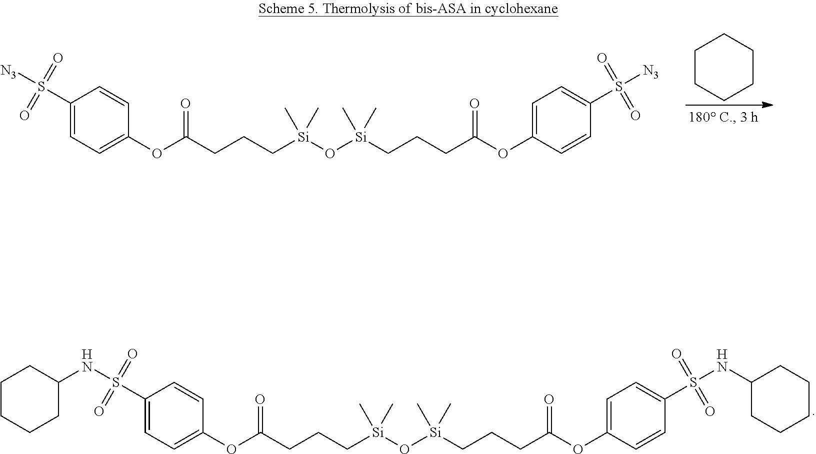 [SMILES: C[Si](C)(CCCC(=O)Oc1ccc(S(=O)(=O)N=[N+]=[N-])cc1)O[Si](C)(C)CCCC(=O)Oc1ccc(S(=O)(=O)N=[N+]=[N-])cc1 ; C1CCCCC1 ; C[Si](C)(CCCC(=O)Oc1ccc(S(=O)(=O)NC2CCCCC2)cc1)O[Si](C)(C)CCCC(=O)Oc1ccc(S(=O)(=O)NC2CCCCC2)cc1]

To a 15 mL pressure tube was added bis-ASA (1 equiv., 40 μmol, 27 mg) and cyclohexane (911 equiv., 36.8 mmol, 4.00 mL) before it was thoroughly sealed. The reaction vessel was heated at 180° C. for 3 h with a bomb shield in place. After, it was removed from heat and allowed to cool to r.t. before it was concentrated in vacuo. The crude oil was purified by micro-column chromatography with 70:30 Hex to EtOAc to yield the compound as a colorless oil. Yield: 3.9 mg, 12%. Dicyclohexane:bis-ASA adduct. ¹H NMR (500 MHz, CDCl₃, 298 K) δ 7.86 (d, 4H), 7.20 (d, 4H), 4.80 (d, J=7.6 Hz, 2H), 3.17 (qd, J=10.1, 3.9 Hz, 2H), 2.61 (t, J=7.4 Hz, 4H), 1.85-1.75 (m, 8H), 1.69-1.61 (m, 4H), 1.59-1.48 (m, 2H), 1.29-1.09 (m, 10H), 0.68-0.61 (m, 4H), 0.10 (s, 12H). ¹³C NMR (151 MHz, CDCl₃, 298 K) δ 171.46, 153.85, 138.93, 128.56, 122.42, 52.89, 37.74, 34.10, 25.26, 24.77, 19.17, 18.12, 0.49. QDA-MS calcd. for C₃₆H₅₆N₂O₉S₂Si₂, [M+H]⁺=781.1 m/z, found 781.3 m/z.

### Formulation of Crosslinked Homopolymers and Blends by Reactive Extrusion.

General bis-ASA crosslinking procedure. To a 50 mL conical vial was added 5 g of powderized polymer(s), along with a select weight percent of bis-ASA and the KF:DB-18-C-6 catalyst (10 mol % relative to bis-ASA) and was thoroughly mixed for 5 minutes. The mixture was fed into the twin-screw extruder and melt-blended at 180° C. with 60 rpm for 10 minutes under a blanket of nitrogen gas. The extrudate was flushed and subsequently compression-molded (HDPE-x: 180° C., 30 min; LDPE-x: 150° C., 10 min; iPP-x, PS-x, LDPE: PETg binary blend, and mixed waste: 195° C., 10 min; PETg-x: 180, 10 min) prior to physical and rheological testing. For the HDPE:iPP binary blend, melt-extrusion was performed at 190° C. with 60 rpm for 10 minutes under nitrogen, and samples were melt-pressed with Specac Atlas™ Manual 15T Hydraulic Press at 160° C. for 5 min under 4 T.

TABLE 1
Crosslinked single polymer formulations during reactive extrusion

| | | bis-ASA | KF:DB18-C-6 |
|---|---|---|---|
| Sample | Polymer (g) | (wt %; mg) | (mol %; mg) |
| HDPE-x | HDPE 5 g | 5: 250 | 10; 16 |
| LDPE-x | LDPE 5 g | 5; 250 | 10; 16 |
| iPP-x | iPP 5 g | 2; 100 | 10; 6 |
| PS-x | PS 5 g | 2; 100 | 10; 6 |
| PETg-x | PETg 5 g | 5; 250 | 10; 16 |

TABLE 2
Crosslinked polymer blend formulations during reactive extrusion

| | | bis-ASA | KF:DB18-C-6 |
|---|---|---|---|
| Sample | Polymer (g; wt %) | (wt %; mg) | (mol %; mg) |
| LDPE:PET g-x | LDPE 3 g; 60 wt % | 3.5; 175 | 10; 11 |
| | PETg 2 g; 40 wt % | | |
| HDPE:iPP-x | HDPE 3.5 g; 70 wt % | 2; 100 | 10; 6 |
| | iPP 1.5 g; 30 wt % | | |
| Mixed Waste-x | LDPE 1.33 g; 27 wt % | 1; 50 | 10; 3 |
| | HDPE 1.08 g; 22 wt % | | |
| | iPP 1.42 g; 28 wt % | | |
| | PS 0.5 g; 10 wt % | | |
| | PETg 0.67 g; 13 wt % | | |

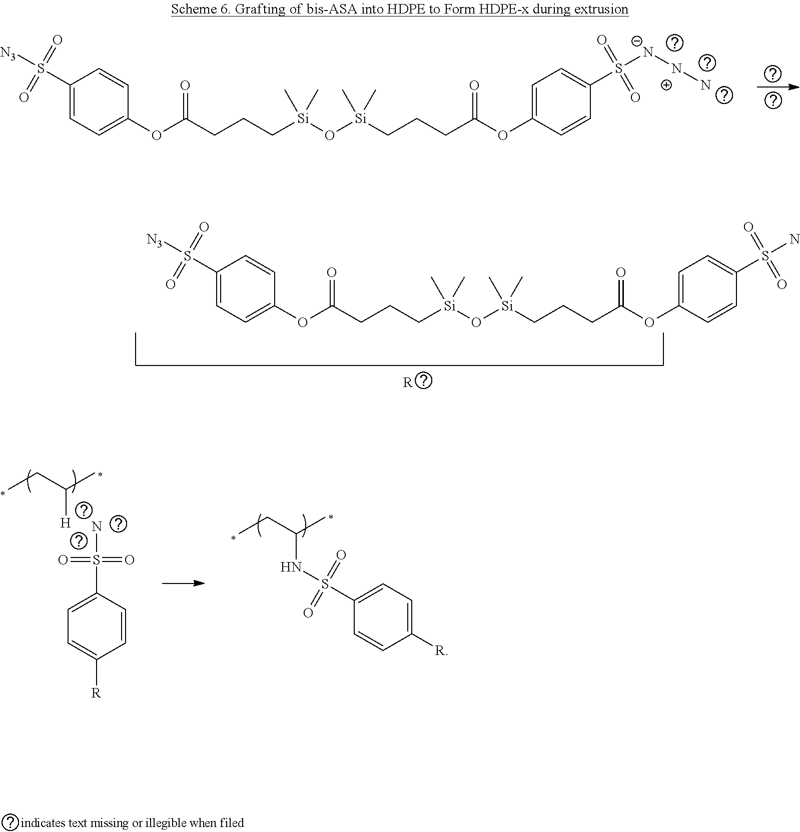

Dynamically-crosslinked polymer reprocessing procedure. For each of the five reprocessing cycles, the material was cut into small pieces approximately 3 mm in size and collected into a 50 mL conical vial containing 5 mg of butylated hydroxytoluene (BHT) to serve as a radical trap. The sample was mixed thoroughly, then fed into an extruder heated at 180° C. The material was flushed at 60 rpm before the extrudate was collected, compression-molded (150° C. for 10 min) and used for tensile testing once more. After, the specimens were collected, cut, and the subsequent cycle was started.

Analysis of soluble fraction of HDPE:iPP-x. An approximately 100 mg piece of HDPE:iPP-x polymer blend (70:30) was heated at 150° C. in 10 mL mesitylene overnight over activated 3 A activated molecular sieves. The soluble fraction was precipitated in 70 mL methanol and dried in a vacuum oven. The ratio of HDPE to iPP in the soluble fraction was calculated from integrations in the ¹H NMR spectrum. The methyl peak of iPP at ˜0.9 ppm was calibrated to 3.00 for the three protons. One of the diastereotopic methylene protons of iPP overlaps with the methylene peaks of HDPE at ˜1.3 ppm. Therefore, the integration of 6.11 should be reduced by 1.00 for one of the diastereotopic methylene protons in iPP, leaving an integration of 5.11 attributed to the 4 methylene protons of the HDPE backbone.

HDPE: (5.11 int/4H)*28.05 g/mol=35.8 35.8/70.9*100%=46.0 wt %

iPP: 3.00 int/3H*42.08 g/mol=42.08 42.08/70.9*100%=54.0 wt %

### Physical and Thermomechanical Testing

Gel fraction analysis. For a given sample, a piece of crosslinked sample (30-100 mg) was swollen in 15 mL of anhydrous solvent (HDPE-x, LDPE-x, and PS-x: trichlorobenzene, 120° C.; iPP-x: mesitylene, 140° C.; PETg: dioxane, 80° C.) for 16 h. The swollen gel was then isolated and dried under reduced pressure and mild heating (70° C.) until the weight became constant. Gel fraction was calculated as a percentage of the final mass of the dried material divided by its initial mass.

TABLE 3
Gel content of HDPE-x

| Sample | Initial Mass (mg) | Final Mass (mg) | Gel Fraction (%) |
|---|---|---|---|
| 1 | 29.5 | 10.3 | 34.9 |
| 2 | 50.2 | 18.4 | 36.7 |
| 3 | 44.0 | 16.4 | 37.2 |
| | | Average ± σ | 36.3 ± 1.2 |

TABLE 4
Gel content of LDPE-x

| Sample | Initial Mass (mg) | Final Mass (mg) | Gel Fraction (%) |
|---|---|---|---|
| 1 | 44.1 | 21.2 | 48.1 |
| 2 | 55.5 | 26.2 | 47.2 |
| 3 | 44.6 | 21.1 | 47.3 |
| | | Average ± σ | 47.5 ± 0.5 |

TABLE 5
Gel content of iPP-x

| Sample | Initial Mass (mg) | Final Mass (mg) | Gel Fraction (%) |
|---|---|---|---|
| 1 | 37.6 | 26.5 | 70.5 |
| 2 | 32.9 | 22.6 | 68.7 |
| 3 | 36.6 | 28.3 | 77.3 |
| | | Average ± σ | 72.2 ± 4.5 |

TABLE 6
Gel content of PS-x

| Sample | Initial Mass (mg) | Final Mass (mg) | Gel Fraction (%) |
|---|---|---|---|
| 1 | 44.6 | 30.6 | 68.6 |
| 2 | 48.7 | 31.9 | 65.5 |
| 3 | 53.2 | 38.2 | 71.8 |
| | | Average ± σ | 68.6 ± 3.2 |

TABLE 7
Gel content of PETg-x

| Sample | Initial Mass (mg) | Final Mass (mg) | Gel Fraction (%) |
|---|---|---|---|
| 1 | 96.6 | 46.7 | 48.3 |
| 2 | 57.9 | 26.9 | 46.5 |
| 3 | 68.9 | 34.3 | 49.8 |
| | | Average ± σ | 48.2 ± 1.7 |

Dissolution of bis-ASA crosslinked polymers with TBAF. A piece of crosslinked sample (40 mg) was swollen in 18 mL of xylenes for 16 h at 120° C. To the vial was added approximately 7 mg of tetrabutylammonium fluoride trihydrate thrice over the course of 3.5 h while the mixture heated and stirred, due to the facile degradation of TBAF at elevated temperatures. After the indicated time, the sample had totally dissolved with no remaining gel.

Creep measurement. Creep tests were performed using a 12 mm parallel plate geometry with 500 Pa of applied stress and a normal force of 3 N to maintain sufficient contact. Samples were prepared by punch-cutting with a 12 mm steel die and allowed to equilibrate at temperature for 5 min prior to the run.

Stress relaxation measurement. Stress relaxation experiments were performed using a 12 mm parallel plate geometry with 3% strain, a strain rise time of 0.01 s, and a normal force of 3 N to maintain sufficient contact. For an Arrhenius treatment of PETg, this polymer's stress relaxation data was treated with a stretched exponential (Kohlrausch-Williams-Watts) function with a beta value of 0.1, and the mean relaxation time (t*) of each curve was calculated from the extracted relaxation time according to EQ. 1:

$${τ}^{*} = \frac{τ}{β} Γ ( \frac{1}{β} ) \qquad ( EQ . 1 )$$

For other polymers, the relaxation moduli G* are reported with respect to time. Samples were prepared by punch-cutting with a 12 mm steel die and allowed to equilibrate at temperature for 5 min prior to the run.

Frequency sweep rheology measurement. Frequency sweep rheology experiments were performed using a 12 mm parallel plate geometry with 0.5% strain and a normal force of 3 N to maintain sufficient contact. Samples were prepared by punch-cutting with a 12 mm steel die and allowed to equilibrate at temperature for 5 min prior to the run.

Dynamic Mechanical Thermal Analysis (DMTA) of blends. DMTA experiments were performed in tensile mode using 0.1% strain at a frequency of 1 Hz with a temperature ramp of 3° C./min. Samples measured approximately 2 mm×1.5 mm×12 mm.

Differential Scanning Calorimetry (DSC) measurements. DSC experiments were performed using an Tzero aluminum pan under an inert atmosphere of nitrogen. To study the decomposition of the bis-ASA crosslinker, a single heat ramp of 10° C./min was used and the data of its singular temperature ramp is reported. In a typical run of polymer, 5 mg of material was heated at a rate of 20° C./min to remove thermal history, cooled at a rate of 10° C./min, then heated once more at 20° C./min. Data and crystallinity values are reported for each polymer material during its second heating cycle. The enthalpies of fusion used were 292.3 J/g for PE and 209.1 J/g for iPP. For studying the recovery of crystallinity via annealing, HDPE and HDPE-x were heated at 100° C. under vacuum for 16 h, then subsequently tested.
HDPE: 172.97 J/g→59.18% crystalline HDPE-x: 141.19 J/g→48.3% crystalline
   Annealed HDPE: 181.76 J/g→62.2% crystalline
   Annealed HDPE-x: 171.66 J/g→58.7% crystalline
LDPE: 70.02 J/g→24.0% crystalline LDPE-x: 63.94 J/g→21.9% crystalline
iPP: 87.49 J/g→41.8% crystalline iPP-x: 79.65 J/g→38.1% crystalline

Thermal Gravimetric Analysis (TGA) measurements. TGA experiments were performed using approximately 7 mg of sample with a temperature ramp of 20° C./min. For tests under an inert atmosphere of nitrogen (50 mL/min N₂), the sample was placed on a platinum pan and measured with a TA Instruments Q500. For those conducted under an atmosphere of air (80 mL/min N₂, 20 mL/min O₂), the sample was loaded into an aluminum crucible and measured with a Netzsch STA 449 F3 Jupiter.
HDPE: 50% weight loss at 486° C. (N₂); 403° C. (air) HDPE-x: 50% weight loss at 479° C. (N₂); 432° C. (air)
   LDPE: 50% weight loss at 477° C. (N₂) LDPE-x: 50% weight loss at 478° C. (N₂)
   iPP: 50% weight loss at 468° C. (N₂) iPP-x: 50% weight loss at 453° C. (N₂)
   PS: 50% weight loss at 431° C. (N₂) PS-x: 50% weight loss at 432° C. (N₂)
   PETg: 50% weight loss at 441° C. (N₂) PETg-x: 50% weight loss at 438° C. (N₂)

Uniaxial tensile testing. Uniaxial tensile experiments were performed using samples that were compression molded or melt-pressed between stainless steel molds into dumbbell shapes (ISO 527-2 type 5B; see above for molding conditions). Samples were tested at an appropriate crosshead velocity (HDPE and HDPE-x: 10 mm/min; LDPE, LDPE-x, and recycled LDPE-x: 50 mm/min; iPP and iPP-x: 1.5 mm/min; HDPE:iPP binary blend: 10 mm/min; LDPE:PETg binary blend and mixed waste: 5 mm/min). For homopolymer systems, a Canon EOS 5D Mark II Full Frame DSLR camera equipped with macro lens and the OpenCV package in Python was used to monitor two 0.5 mm radius dots of electrical tape, to measure the strain of the gauge length.

TABLE 8
Uniaxial tensile properties of binary polymer blends.

| Sample | Toughness (MJ m⁻³) | Elongation (%) |
|---|---|---|
| LDPE:PETg-x | 3.4 ± 0.5 | 32.3 ± 2.9 |
| LDPE:PETg | 1.2 ± 0.2 | 15.9 ± 0.4 |
| HDPE:iPP-x | 18.3 ± 0.2 | 73.9 ± 4.9 |
| HDPE:iPP | 7.4 ± 0.5 | 24.9 ± 0.5 |

Scanning Electron Microscopy (SEM) imaging. SEM experiments were performed using an FEI Magellan 400 XHR with an accelerating voltage of 10 kV. Samples were cryo-fractured in liquid nitrogen before an EMS 150T Sputter Coater was used to apply a coat of iridium before imaging.

Small Molecule Model Studies. The symmetric bis-ASA dynamic crosslinker was conveniently synthesized in two steps with good yield (see Schemes 1 and Scheme 2 above). Pilot studies indicated that thermally induced decomposition of sulfonyl azides generated highly reactive nitrene species capable of insertion into both aliphatic and aromatic C—H bonds (see FIG. 1B), facilitating organic transformation, polymer functionalization, and crosslinking. To ensure the designed bis-ASA is suitable at typical plastic melt processing temperatures, the thermal decomposition of the synthesized bis-ASA crosslinker was monitored by differential scanning calorimetry (DSC), revealing a peak decomposition at 190° C. (see FIG. 1C). This is more than 50° C. higher than the peak decomposition temperature of the bis-diazirine crosslinkers reported previously, representing a notable advance as most plastics are melt processed at or above 180° C. industrially. Furthermore, sulfonyl azides thermally decompose to form a long-lived singlet state nitrene capable of C—H insertion. This was confirmed by heating the bis-ASA crosslinker in cyclohexane at 180° C. for 3 h (FIG. 1D and Scheme 5). Using cyclohexane as a model alkane, the bis-ASA(Cy)₂ adduct was obtained in yields on par with the analogous carbene reaction for the bis(diazirine) crosslinkers heated in cyclohexane at 130° C. To further assess the reactivity of singlet nitrenes toward different type of C—H bonds, another model reaction was conducted by heating an aromatic sulfonyl azide (tosyl azide) in 2,4-dimethylpentane, the smallest symmetrical molecule containing primary, secondary, and tertiary C—H bonds. Thermal decomposition of tosyl azide in 2,4-dimethylpentane at 180° C. for 1 h led to the generation of three regioisomers (see Scheme 4). From ¹H NMR (see FIG. 1E and FIGS. 4-12), the reactivity ratio for the singlet nitrene insertion toward primary, secondary, and tertiary C—H bonds were calculated to be 1:3.4:8.0. The enhanced reactivity of more substituted C—H bonds for nitrene insertion is presumably due to their increased electron density, a result of hyperconjugation. These model studies demonstrate the suitability of the bis-ASA crosslinker toward the demanding processing temperatures of commodity plastics.

Dynamic Crosslinking of Single Polymers. Next, the general applicability of bis-ASA crosslinker for in situ dynamic crosslinking of a variety of plastics was examined, including both chain-growth (PS, LDPE, HDPE, iPP) and step-growth (PETg) polymers. To show practical relevance and scalability, all in situ crosslinking reactions were carried out by simple solvent-free melt extrusion at 180-190° C. using a twin-screw extruder. This is in contrast to the previously reported bis-diazirine polymer crosslinking which typically begins by solvent-coating the crosslinker onto polymers followed by an oven-baking process at 130° C. To achieve optimal crosslinking efficiency, various parameters play a role, with an important consideration being the synchronization of reactive species generation with processing time. This is important for radical-based crosslinking in polymer reactive extrusion, where the choice of radical initiators is made by aligning their half-life with the extrusion residence time. It was postulated that a similar kinetic match is important for the reactive carbene or nitrene species. Based on reported kinetic data, the estimated half-lives for generating reactive carbene from diazirine and nitrene from ASA are 7.3 seconds and 4.55 min at 180° C. respectively. With a typical reactive extrusion residence time of ˜5-20 min, the nitrene generation kinetics of the bis-ASA crosslinker align seamlessly with standard plastic melt processing temperatures.

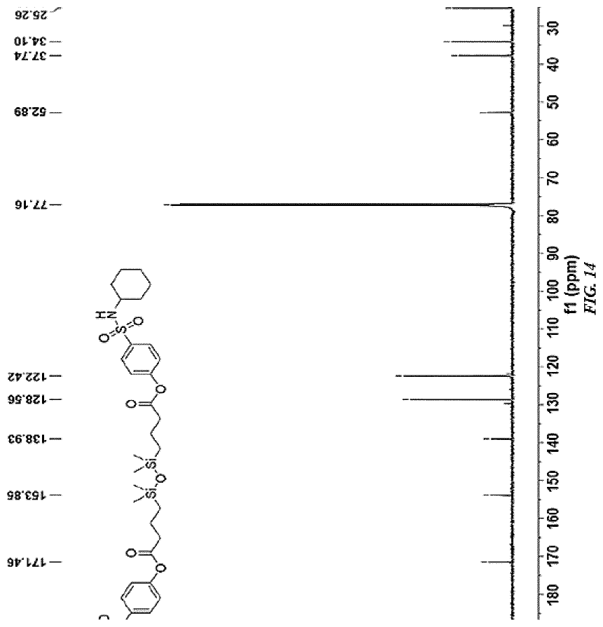

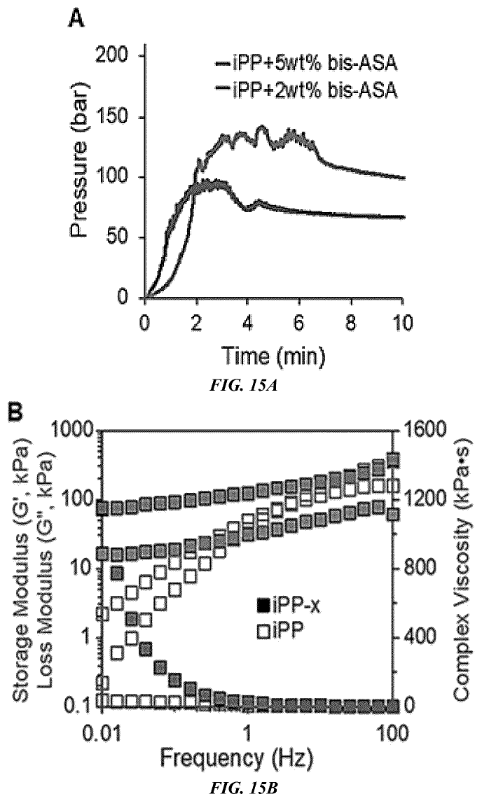

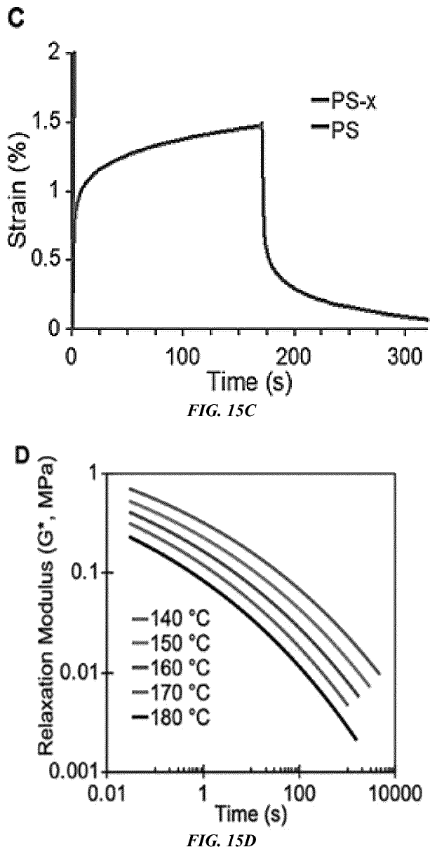

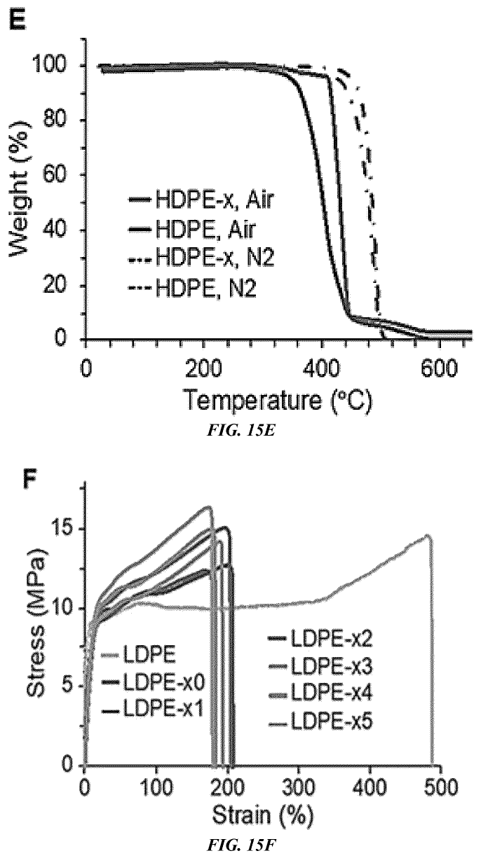

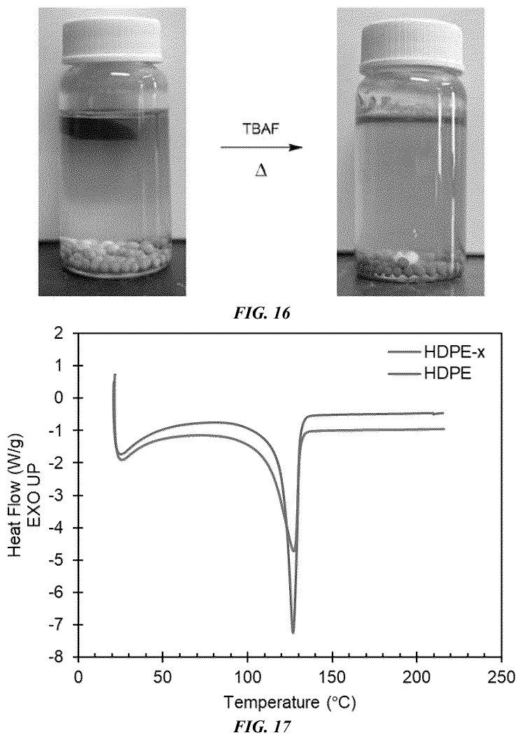

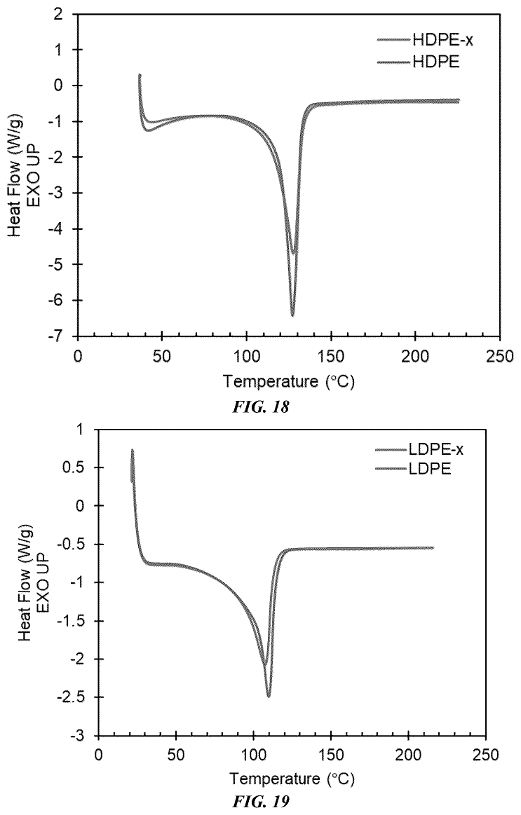

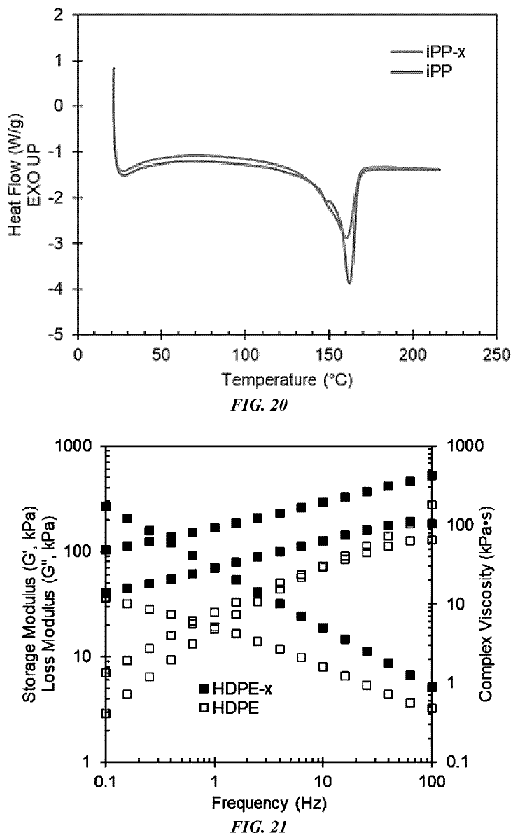

Commodity plastics, including HDPE, LDPE, iPP, PS, and PETg, were individually melt-blended with differing amounts of bis-ASA (1-5 wt %) at 180° C. for 10 min (see Table 1). During reactive extrusion, the bis-ASA crosslinker thermally decomposes, creating a reactive singlet nitrene species in situ, which efficiently inserts into C—H bonds on different polymer chains, leading to dynamic crosslinking. This process is evidenced by the increasing extruder pressure over time, with larger loadings of the bis-ASA crosslinker causing more significant pressure changes (see FIG. 15A). The in situ crosslinking was confirmed by quantifying the gel fraction for all extruded polymers in good solvents under extended heat (see Tables 3-7), which revealed some differences in reactivity for different polymers. For example, while 5 wt % of bis-ASA yielded a gel fraction of 36% for HDPE, only 2 wt % of bis-ASA is needed to afford 72% gel fraction for iPP. Given that our small molecule model reaction demonstrates increased reactivity of singlet nitrene toward tertiary C—H bonds (see FIG. 1E), the higher gel fraction observed in iPP is likely due to higher reactivity of the singlet nitrene with the abundant tertiary C—H bonds present in iPP chains. However, the variation in molecular weight between the two polymers may also contribute to differences in gel fraction. To further verify the crosslinking was formed by the bis-ASA dynamic crosslinker, crosslinked HDPE was shown to completely dissolve in xylenes with the addition of excess tetrabutylammonium fluoride (TBAF), indicating that all crosslinks are formed by the siloxane-containing bis-ASA crosslinker in the networks (see FIG. 16 and Scheme 7). Moreover, differential scanning calorimetry (DSC) revealed that all samples modified with the bis-ASA crosslinker had reduced degrees of crystallinity; for example, in HDPE the crystallinity decreased from 59% in the control to 48% in the material crosslinked with 5 wt % bis-ASA (see FIGS. 17-20). However, the crystallinity of the modified HDPE could be recovered to 58.73% after annealing at 100° C. for 16 h (see FIG. 18), suggesting that the exchange of the dynamic crosslinkers upon heating allows for chain rearrangements during the annealing process.

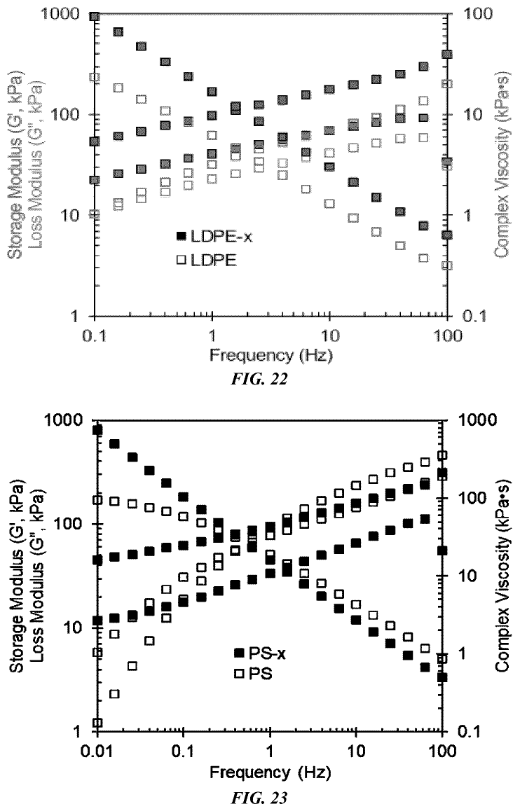

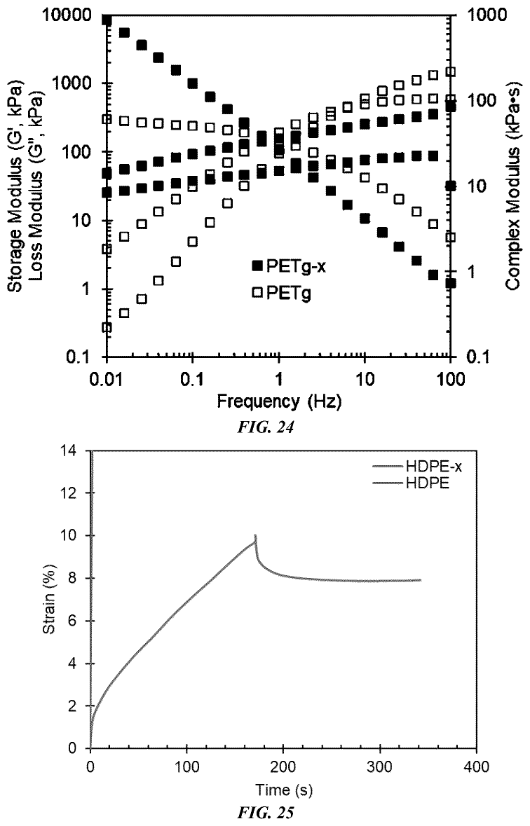

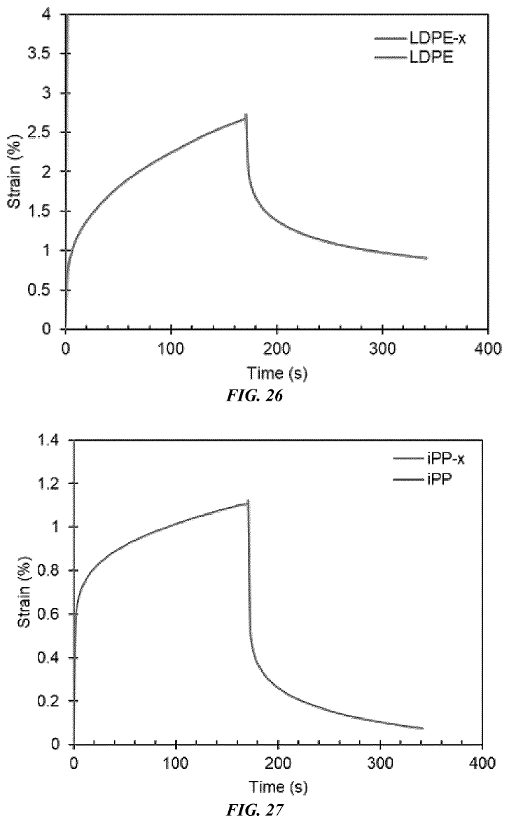

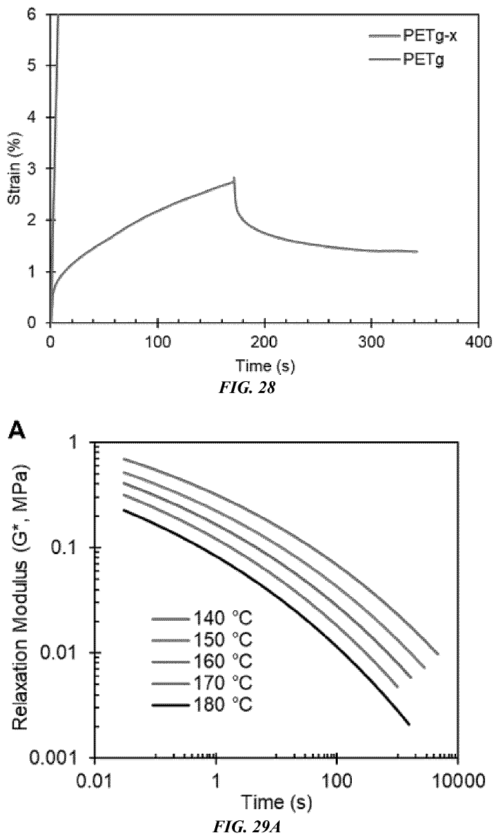

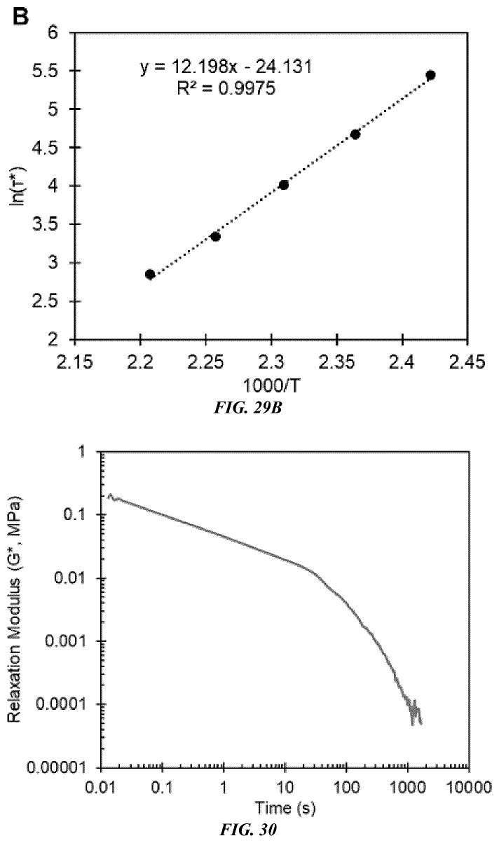

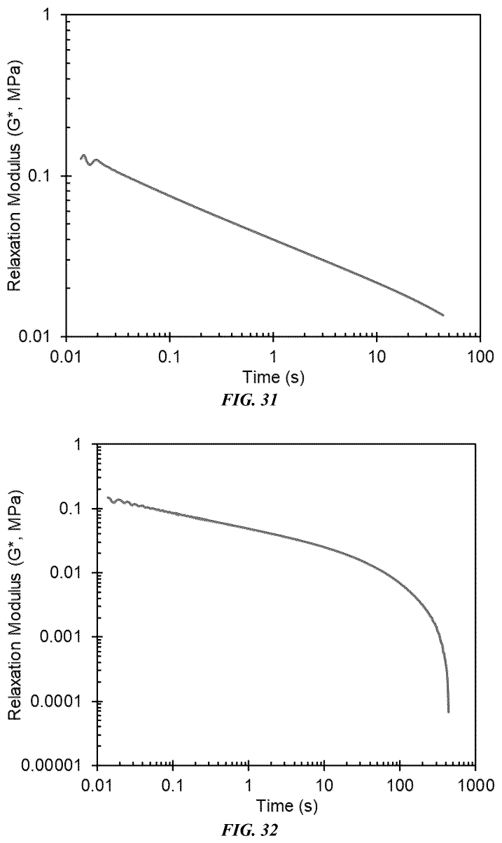

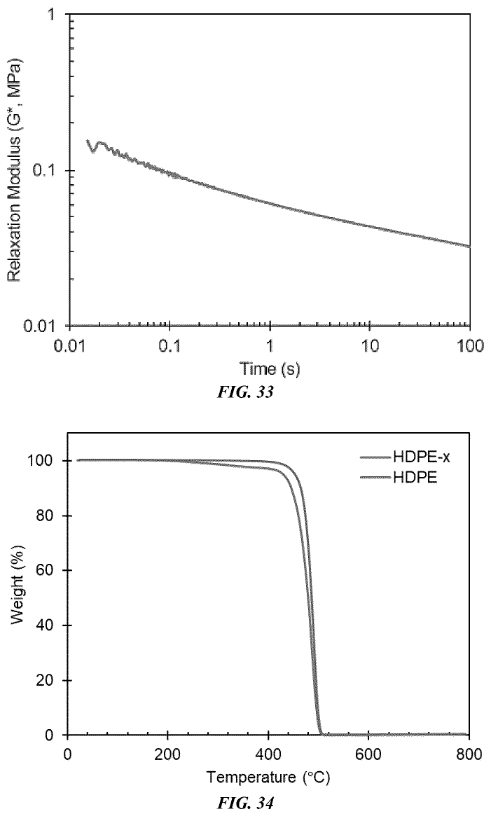

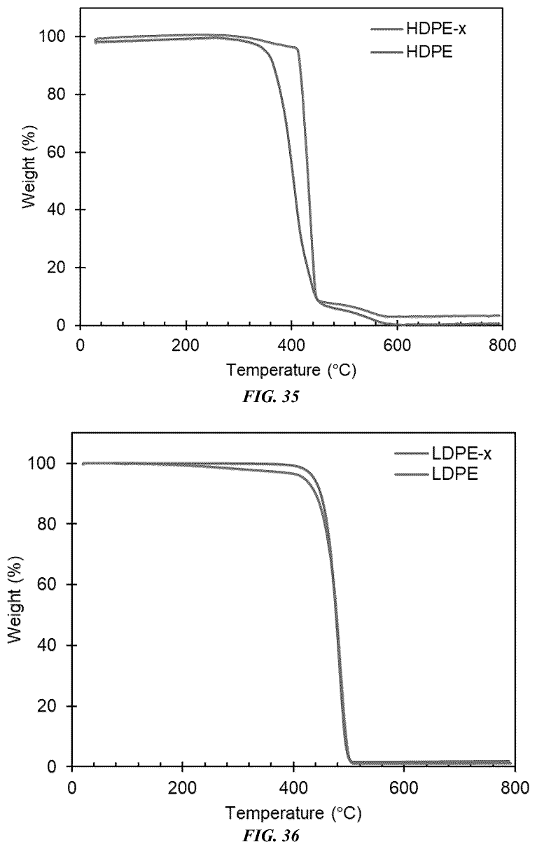

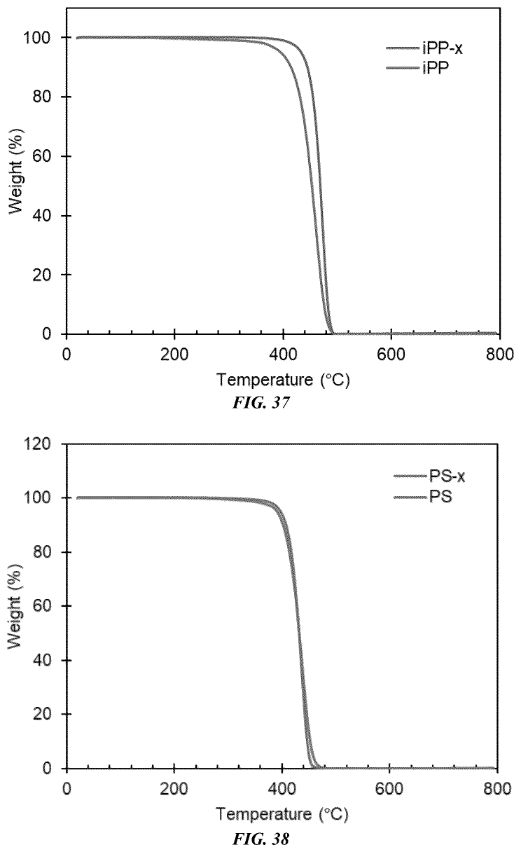

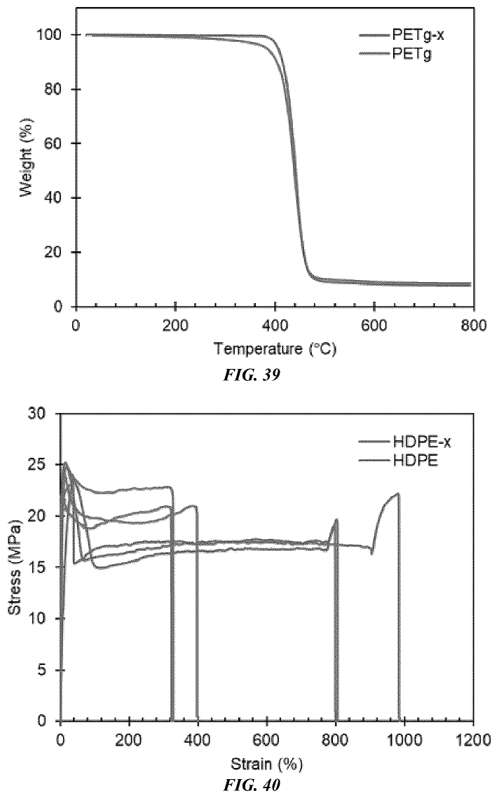

In alignment with the principles of vitrimer design, the dynamic crosslinking of pure plastics through the bis-ASA technology was able to endow the plastics with thermoset performance and thermoplastic recyclability. Indeed, bis-ASA dynamic crosslinking significantly improved the mechanical performance of thermoplastics while maintaining excellent thermal reprocessability. Above the melting transition of a given polymer, the storage modulus of the dynamically crosslinked sample was typically two to three orders of magnitude greater than the control samples at low shearing frequency. However, the dynamically crosslinked plastics exhibited more pronounced shear dependence, allowing the materials to attain low viscosities comparable to those of their linear counterparts at high shearing frequency (see FIG. 15B and FIGS. 21-24). The crosslinked polymers displayed enhanced creep resistance compared to the linear polymers (see FIG. 15C and FIGS. 25-28). For example, while linear PS had a low melt strength and flowed easily at 190° C., the dynamically crosslinked PS (designated as PS-x, the same notation is used for other samples) showed substantial creep resistance and excellent creep recovery at this temperature (see FIG. 15C). The dynamic exchange of the siloxane bridges enables the reconfiguration of network topology, thus allowing the crosslinked network to access flow-state reprocessing at elevated temperatures. This was first demonstrated by stress-relaxation at elevated temperatures (see FIG. 15D and FIGS. 29A, 30-33). For example, variable temperature stress relaxation of the PETg-x revealed an Arrhenius temperature dependence with an apparent activation energy (Ea) of 101.4 kJ mol-1 (see FIG. 15D and FIG. 29B), indicating dynamic exchange for the F⁻-catalyzed siloxane exchange at high temperature. This suggests that the bis-ASA crosslinked plastics are well-suited for typical melt-processing under high-shear environments. Finally, the thermal stability of the bis-ASA crosslinked materials was compared with their linear controls by thermogravimetric analysis (TGA), which showed negligible differences under an atmosphere of nitrogen, whereas under air, the temperature of half decomposition (T_{d,1/2}) increased by 29° C. in the HDPE-x relative to its control, revealing an increase in the oxidative stability (see FIG. 15E and FIGS. 34-39). These data validate the robustness of the bis-ASA crosslinking chemistry.

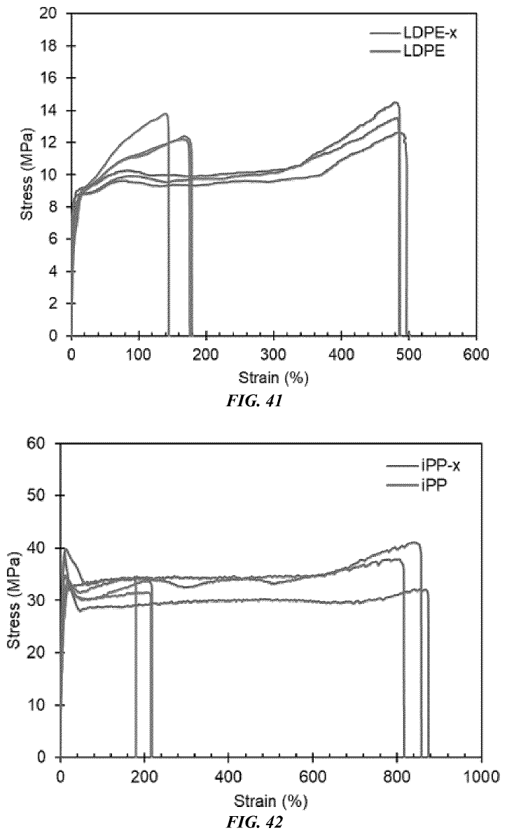

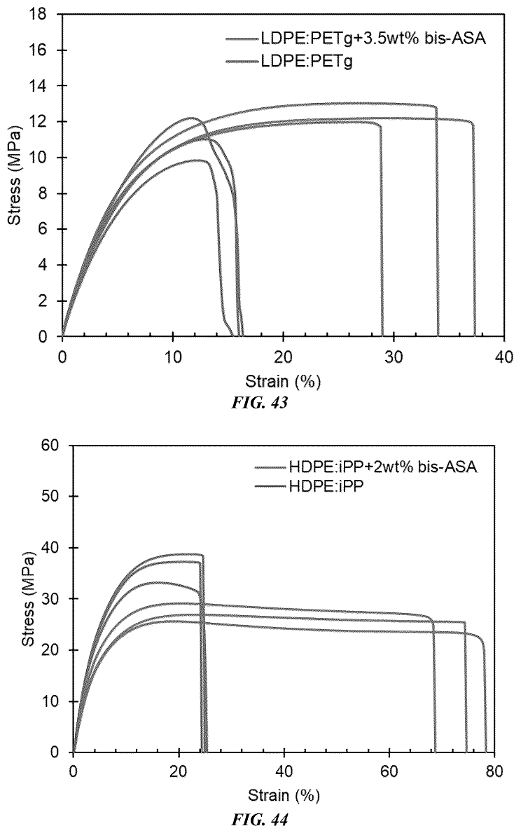

The stability of both the ASA motif and the siloxane dynamic linkage combined with the fluoride-catalyzed fast siloxane exchange allowed for reprocessing the crosslinked samples repetitively without reducing the mechanical properties (see FIG. 15F). The strain-at-break for the bis-ASA crosslinked samples is lower than their linear polymer controls, which is expected because crosslinking is known to inhibit elongation. The reduction in extensibility is compensated by the significantly enhanced mechanical strength, highlighting a true advantage of dynamic crosslinking (see FIG. 15F, and FIGS. 40-42). Taking together the data presented so far, an easily accessible bis-ASA dynamic crosslinker has been developed that can efficiently introduce dynamic crosslinks onto various plastics through solvent-free melt extrusion at industrially relevant temperatures. This offers a robust and scalable dynamic crosslinking chemistry that we will further investigate for compatibilizing immiscible plastics.

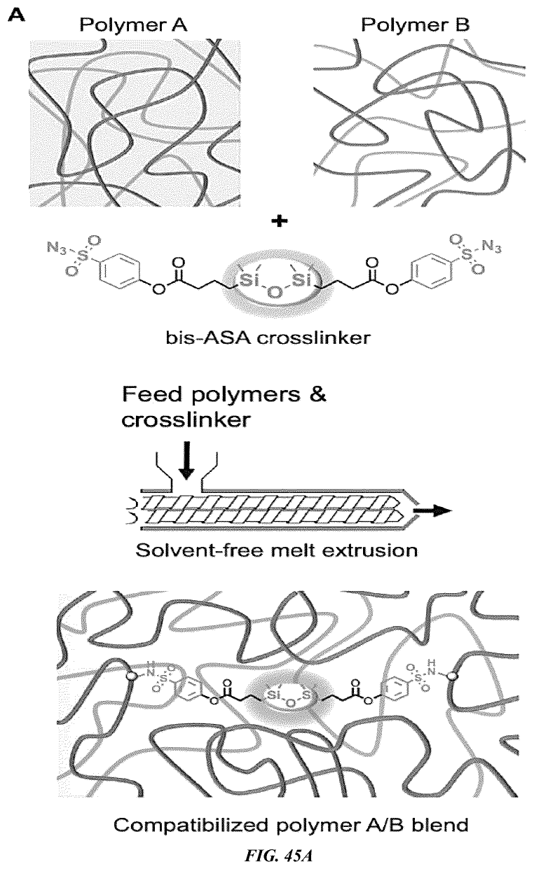

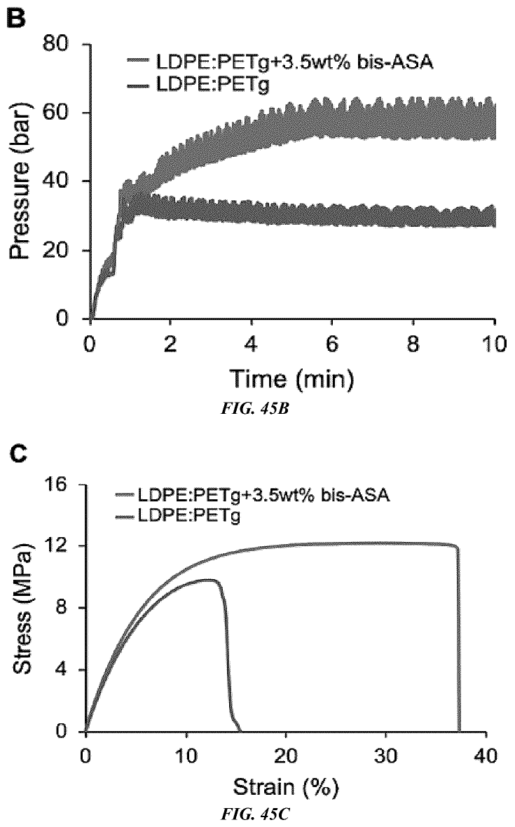

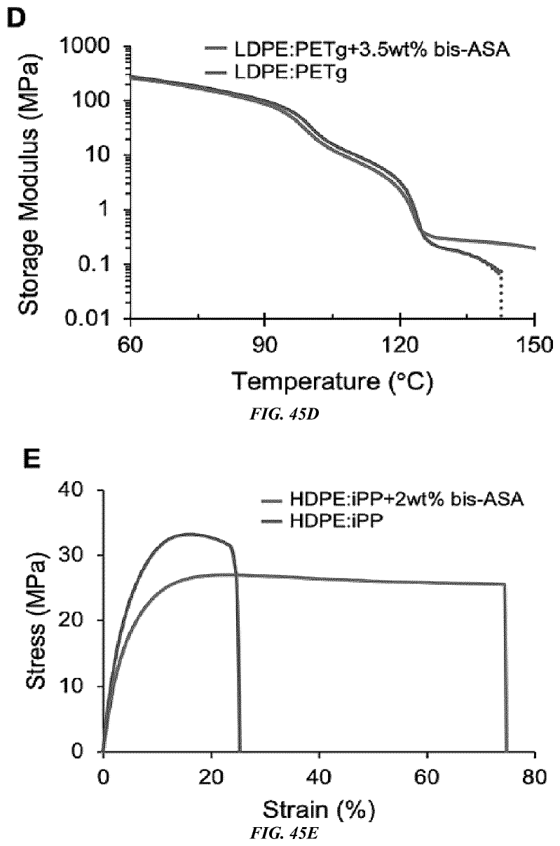

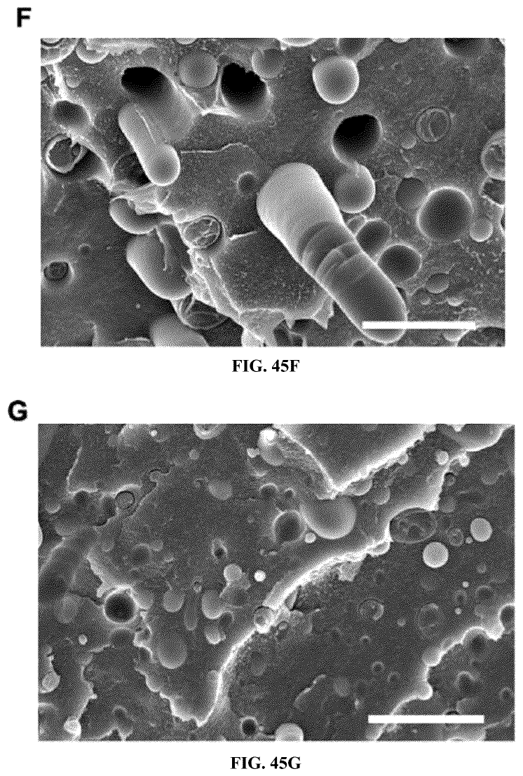

Compatibilization of Binary Polymer Blends. To demonstrate the applicability of bis-ASA crosslinking chemistry for compatibilizing immiscible polymers, mixed plastics were melt-blended with bis-ASA crosslinker by solvent-free reactive extrusion at 180 or 190° C. For initial study, a representative binary blend of LDPE (chain-growth, nonpolar) and PETg (step-growth, polar) in a ratio of 60:40 by mass was melt processed at 180° C. by the aforementioned reactive extrusion method with 3.5 wt % bis-ASA crosslinker (see FIG. 45A and Table 2). During extrusion processing, there was an increase in extruder pressure for the polymer blend with bis-ASA as compared to its control (see FIG. 45B), indicating dynamic crosslinking during the extrusion. Additionally, upon uniaxial tensile testing, the dynamically crosslinked blend showed 203% improvement in its strain-at-break and 276% improvement in toughness (see FIG. 45C). During DMTA analysis, the resulting dynamically crosslinked blend exhibited sustained mechanical integrity beyond the glass transition of PETg and the melting temperature of LDPE. This robustness was attributed to the presence of the siloxane dynamic crosslinks, which effectively prevented yielding, in contrast to the control blend (see FIG. 45D). This leads to enhanced dimensional stability at elevated temperatures, showcasing a significant advantage of the dynamically crosslinked blends. For a nonpolar blend of HDPE and iPP (in a 70:30 ratio by mass) melt extruded at 190° C., a similar improvement to the mechanical properties was observed for the dynamically crosslinked system (297% improvement in strain-at-break and 247% in toughness, see FIG. 45E). Although crosslinking normally diminishes polymer extensibility, the enhanced compatibilization of two immiscible polymer phases counteracts this effect, resulting in materials with improved extensibility and toughness. Further quantitation of the soluble fraction in the compatibilized HDPE:iPP sample proved that both HDPE and iPP were dynamically crosslinked during the reactive extrusion process (see FIG. 46). A recent study reported the in situ generation of triplet state nitrenes for the compatibilization of HDPE/iPP blends. With the diradical character of triplet nitrenes, however, β-scission induced iPP degradation may occur in this system. Scanning electron microscopy (SEM) imaging confirms the improved compatibilization achieved through dynamic crosslinking. The control blend, due to significant differences in chemical structure and polarity between LDPE and PETg, displays extensive phase separation with prominent rod-like structures of PETg dispersed in the LDPE matrix (see FIG. 45F). In contrast, the LDPE:PETg blend with dynamic crosslinking exhibits enhanced phase mixing, featuring relatively small droplets (see FIG. 45G).

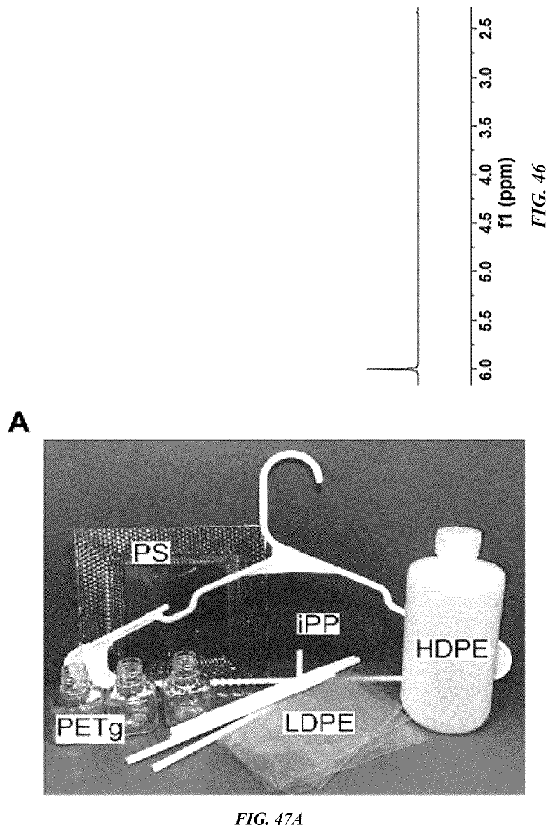

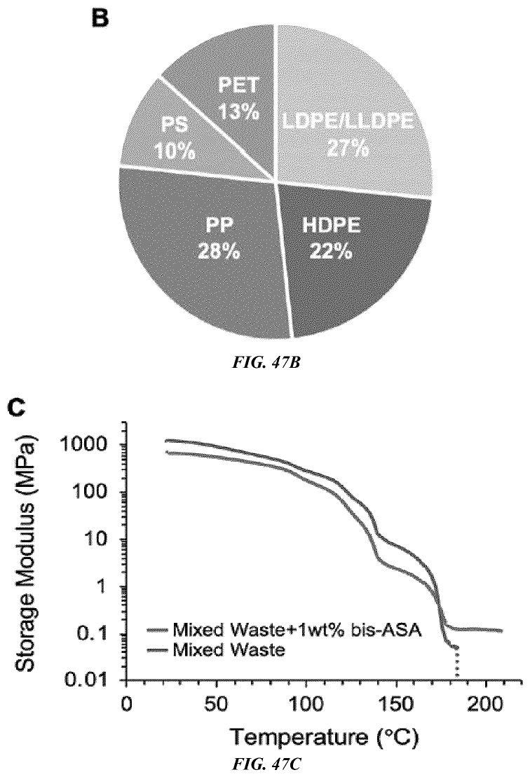

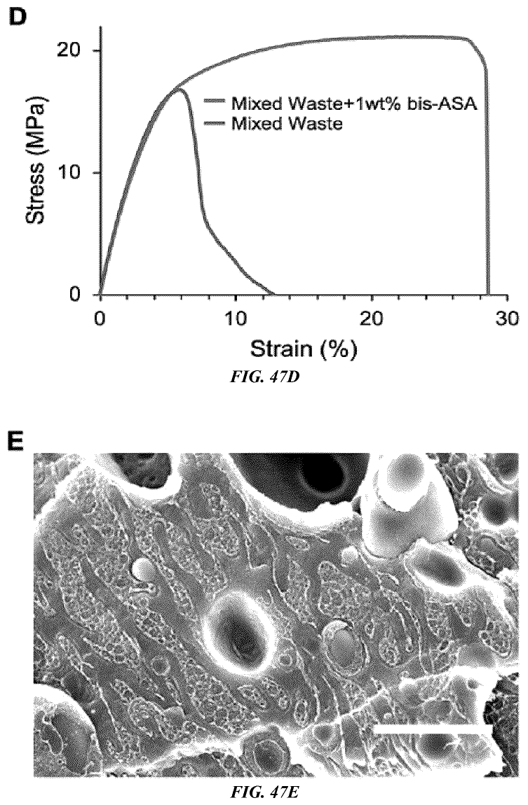

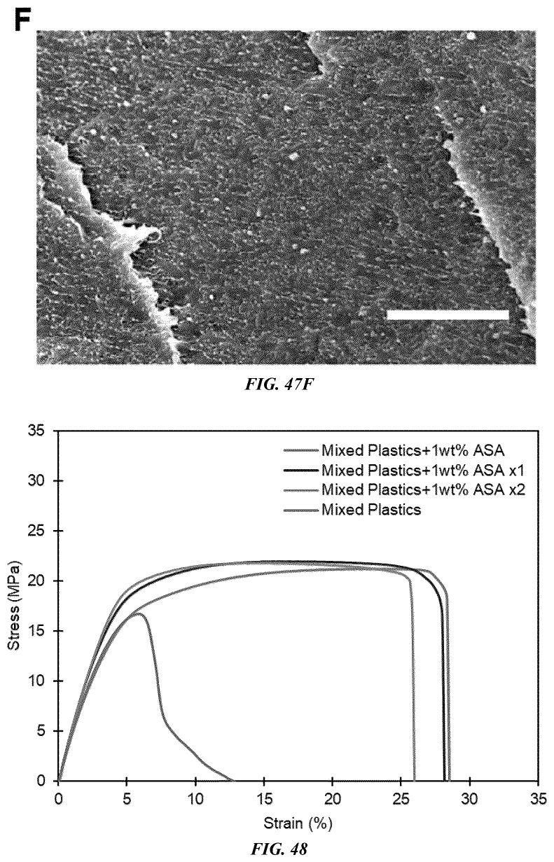

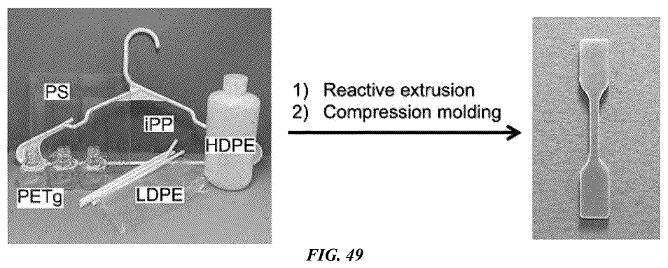

Compatibilization of a Simulated Mixed Plastic Waste. The build-up of plastic waste in the environment is a pressing concern, often involving complex mixed waste streams containing a variety of polymers. The inherent incompatibility of different plastics prevents direct mechanical recycling of mixed plastic waste. To demonstrate the applicability of the technology presented herein to addressing this critical issue, commodity products made from HDPE (bottle), LDPE (bags), iPP (hanger, straws), PS (disposable plates), and PETg (medical bottles) were collected (see FIG. 47A), and melt-blended them in a ratio corresponding to their global consumption (see FIG. 47B) using solvent-free reactive extrusion in the presence of 1 wt % bis-ASA crosslinker. To showcase the robustness of our technology, these commodity plastics were utilized without any purification, retaining any additives (plasticizers, stabilizers, etc.) present in the samples. The resulting material was analyzed by DMTA, revealing multiple thermal transitions owing to the various glass and melting transitions of the numerous polymers (T_{g}'s for PETg and PS at 81° C. and 105° C., respectively; and Tₘ's for LDPE, HDPE, and iPP at 110° C., 128° C., and 162° C., respectively) in the mixed plastic blend, yet the sample modified with 1 wt % bis-ASA crosslinker did not yield after overcoming the highest thermal transition (see FIG. 47C).

Again, the enhanced dimensional stability at elevated temperatures showcases a significant advantage of the dynamically crosslinked blend. Notably, the tensile properties of the dynamically crosslinked mixed plastics demonstrated 214% improvement in its strain-at-break and 500% enhancement in toughness over the control sample, without compromising its tensile strength (see FIG. 47D). In addition, the model mixed plastics compatibilized with 1 wt % bis-ASA could be subsequently reprocessed over multiple cycles while retaining its mechanical properties (see FIG. 48). SEM images show that there exist large phase-separated domains in the control blend (see FIG. 47E), consistent with the poor mechanical performance of the control. In contrast, the microphase morphology of the dynamically crosslinked blend is much more homogeneous (see FIG. 47F), confirming enhanced compatibilization by in situ dynamic crosslinking. These results suggest that the bis-ASA dynamic crosslinking chemistry can be directly applied to compatibilize mixed plastic waste using a solvent-free melt-extrusion process, promising a practical solution for the mechanical recycling of mixed plastic waste.

Conclusion. The disclosure demonstrates a robust and scalable dynamic crosslinking strategy that offers a potential general solution to enhance compatibility for immiscible plastics. Through a novel bis-ASA dynamic crosslinker incorporating aromatic sulfonyl azide, in situ generation of highly-reactive singlet nitrene species facilitates efficient C—H insertion into diverse plastics, forming dynamic crosslinks during solvent-free melt extrusion. The straightforward synthesis of the bis-ASA dynamic crosslinker and the facile extrusion process used for in situ polymer crosslinking suggest that the process could potentially be scalable. Importantly, the high decomposition temperature of bis-ASA (˜190° C.) renders the crosslinker suitable for conventional melt processing of various commodity plastics. Dynamically crosslinked plastics derived from polar, nonpolar, chain-growth and step-growth polymers demonstrate improved mechanical properties while maintaining reprocessability. Solvent-free reactive extrusion effectively compatibilizes model polymer blends with minimal bis-ASA crosslinker content. Moreover, this approach demonstrates efficacy in compatibilizing a simulated mixed plastic waste, encompassing five commodity plastics with distinct characteristics. The resulting polymer blend exhibits significantly enhanced mechanical performance and phase morphology. The bis-ASA technology offers a promising solution to the challenge of mixed plastic waste, promoting the sustainability of plastic lifecycles.

Certain embodiments of the invention have been described. It will be understood that various modifications may be made without departing from the spirit and scope of the invention. Other embodiments are within the scope of the following claims.

1. A dynamic crosslinker that inserts into C—H groups of a polymer or a mixture of polymers, comprising:
a siloxane group;
a plurality of terminal aromatic sulfonyl azide (ASA) groups; and
a plurality of linking groups that connect the terminal ASA groups to the siloxane group,
wherein the crosslinker inserts into C—H groups of a polymer or a mixture of polymers upon decomposition of the ASA groups.

2. The dynamic crosslinker of claim 1, wherein decomposition of the ASA groups generates a nitrene intermediate.

3. The dynamic crosslinker of claim 1, wherein the polymer or mixtures of polymers comprises synthetic polymer(s), semi-synthetic polymer(s) and/or organic polymer(s).

4. The dynamic crosslinker of claim 1, wherein the polymer or mixtures of polymers comprises polymers of cellulose, lignin, hyaluronic acid, chitosan, alginate, polyethylene (PE), polyethylene terephthalate (PET), poly carbonate (PC), high-density polyethylene (HDPE), low-density polyethylene (LDPE), polypropylene (PP), isotactic polypropylene (iPP), polystyrene (PS), polyvinyl chloride (PVC), poly(methyl methacrylate) (PMMA), polyethylene terephthalate (PET), Acrylonitrile Butadiene Styrene (ABS), polyoxymethylene (POM), polyamide (PA), thermoplastic polyurethane (TPU), thermoplastic elastomers (TPE) and/or polyethylene terephthalate glycol (PETg).

5. The dynamic crosslinker of claim 1, wherein the siloxane group has the structure of: 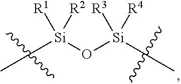
wherein,
R¹-R⁴ are each individually selected from a (C₁-C₆)alkyl group and an aryl.

6. The dynamic crosslinker of claim 5, wherein the siloxane group has the structure of:

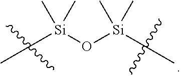 [SMILES: *[Si](C)(C)O[Si](*)(C)C]

7. The dynamic crosslinker of claim 1, wherein the dynamic crosslinker has from 2 to 10 terminal ASA groups.

8. The dynamic crosslinker of claim 1, wherein the plurality of terminal ASA groups have the structure of:

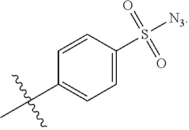 [SMILES: *c1ccc(S(=O)(=O)N=[N+]=[N-])cc1]

9. The dynamic crosslinker of claim 1, wherein the plurality of linking groups have the structure of: 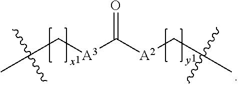
wherein,
x¹ is an integer selected from 0, 1, 2, and 3;
y¹ is an integer selected from 0, 1, 2, and 3;
z¹ is an integer selected from 1, 2, and 3;
A¹ is selected from CR⁵R⁶, NR⁷, O, 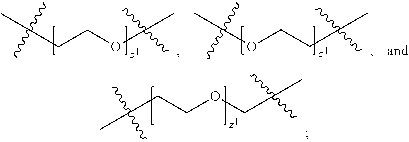
A² is selected from CR⁸R⁹, NR¹⁰, and O; and
R⁵-R¹⁰ are each individually selected from H, D, optionally substituted (C₁-C₆)alkyl, optionally substituted (C₁-C₆)alkenyl, optionally substituted (C₁-C₆)alkynyl, optionally substituted aryl, optionally substituted cycloalkyl, optionally substituted heterocycle, halo, cyano, (C₁-C₅)alkoxy, thiol, sulfide, hydroxyl, aldehyde, carboxylic acid, amine, amide, (C₁-C₆)ketone, and (C₁-C₅)ester.

10. The dynamic crosslinker of claim 9, wherein the plurality of linking groups have a structure selected from:

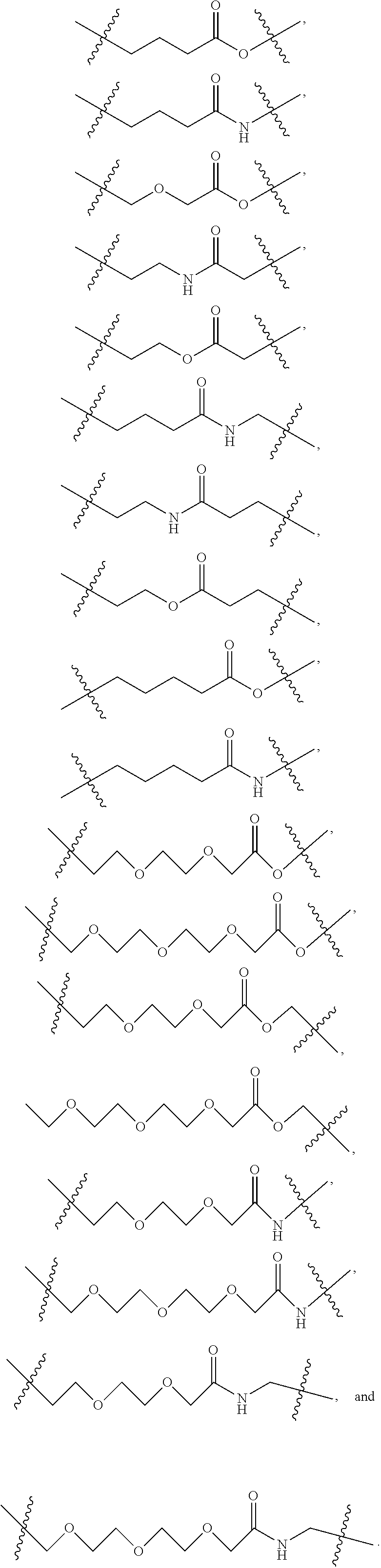

11. The dynamic crosslinker of claim 10, wherein the plurality of linking groups have the structure of:

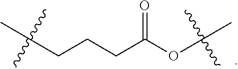 [SMILES: *CCCC(=O)O*]

12. The dynamic crosslinker of claim 1, wherein the crosslinker is a bis-ASA crosslinker having the structure 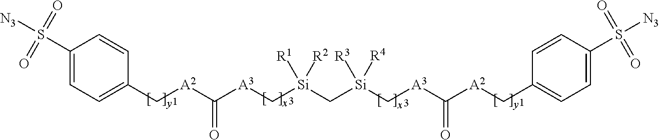
wherein,
x is an integer selected from 0, 1, 2, and 3;
y is an integer selected from 0, 1, 2, and 3;
z is an integer selected from 1, 2, and 3;
A¹ is selected from CR⁵R⁶, NR⁷, O, and 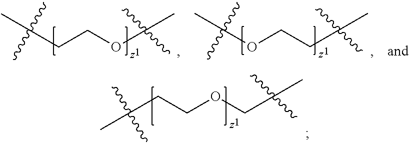
A² is selected from CR⁸R⁹, NR¹⁰, and O;
R¹-R⁴ are each individually selected from a (C₁-C₆)alkyl group and an aryl; and
R⁵-R¹⁰ are each individually selected from H, D, optionally substituted (C₁-C₆)alkyl, optionally substituted (C₁-C₆)alkenyl, optionally substituted (C₁-C₆)alkynyl, optionally substituted aryl, optionally substituted cycloalkyl, optionally substituted heterocycle, halo, cyano, (C₁-C₅)alkoxy, thiol, sulfide, hydroxyl, aldehyde, carboxylic acid, amine, amide, (C₁-C₆)ketone, and (C₁-C₅)ester.

13. The dynamic crosslinker of claim 12, wherein the dynamic crosslinker is a bis-ASA crosslinker having the structure of:

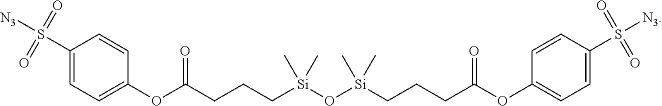 [SMILES: C[Si](C)(CCCC(=O)Oc1ccc(S(=O)(=O)N=[N+]=[N-])cc1)O[Si](C)(C)CCCC(=O)Oc1ccc(S(=O)(=O)N=[N+]=[N-])cc1]

14. A crosslinked polymer or mixture of crosslinked polymers comprising crosslinks having the structure of:

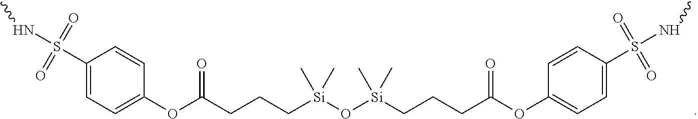

15. The crosslinked polymer or mixture of crosslinked polymers of claim 14, wherein the crosslinked polymer or mixture of crosslinked polymers comprise organic polymer(s), semi-synthetic polymer(s), and/or synthetic polymer(s).

16. A process for introducing dynamic crosslinks into a polymer or a mixture of polymers, comprising:
introducing dynamic crosslinks into a polymer or mixture of polymers by reacting one or more polymers with the dynamic crosslinker of claim 1 at an elevated temperature or under light irradiation to decompose the ASA groups of the dynamic crosslinker.

17. The process of claim 16, wherein the reaction is carried out using an extruder in a solvent-free melt extrusion process at 140° C. to 260° C.

18. The process of claim 16, wherein the polymer or mixtures of polymers comprises synthetic polymer(s), semi-synthetic polymer(s) and/or organic polymer(s).

19. The process of claim 16, wherein dynamic crosslinking of the polymer or mixtures of polymers using the dynamic crosslinker provides for crosslinked polymers with thermoset performance and recyclability.

20. The process of claim 19, wherein the polymer or mixtures of polymers comprises polymers of mixed plastic waste, and the crosslinked plastic waste polymers are recyclable.
